(19) United States
(12) Patent Application Publication
(10) Pub. No.: US 2017/0205631 A1
(43) Pub. Date: Jul. 20, 2017

(54) NARROW BAND LASER APPARATUS AND METHOD FOR POSITIONING LINE NARROW MODULE

(71) Applicant: Gigaphoton Inc., Tochigi (JP)

(72) Inventors: Yoshinobu WATABE, Oyama-shi (JP); Miwa IGARASHI, Oyama-shi (JP); Koji ASHIKAWA, Oyama-shi (JP)

(73) Assignee: Gigaphoton Inc., Tochigi (JP)

(21) Appl. No.: 15/478,683

(22) Filed: Apr. 4, 2017

Related U.S. Application Data
(63) Continuation of application No. PCT/JP2015/081525, filed on Nov. 9, 2015.

(30) Foreign Application Priority Data
Nov. 14, 2014 (JP) PCT/JP2014/080171

(51) Int. Cl. G02B 27/10; H01S 3/101; H01S 3/00; G02B 27/09; H01S 3/03; H01S 3/225

(52) U.S. Cl. CPC G02B 27/1086; H01S 3/03; H01S 3/225; H01S 3/005; G02B 27/0972; H01S 3/101

(57) ABSTRACT

A narrow band laser apparatus may include: a laser chamber; a line narrow module configured to narrow a band width of a laser beam outputted from the laser chamber and return the laser beam to the laser chamber, the line narrow module including a grating; a housing accommodating the line narrow module; three mounts fixed to the housing; and a housing moving device configured to support the housing and the line narrow module by supporting each of the three mounts and move the line narrow module by moving the housing with respect to the laser chamber in a direction substantially perpendicular to a dispersion plane of the grating.

### TECHNICAL FIELD

The present disclosure relates to a narrow band laser apparatus and a method for positioning a line narrow module.

### BACKGROUND ART

The recent miniaturization and increased levels of integration of semiconductor integrated circuits has led to a demand for increases in the resolutions of semiconductor exposure devices. A semiconductor exposure device is referred to as an “exposure device” hereinafter. Accordingly, reduction of the wavelengths of light emitted from exposure light sources is improving. Typically, gas laser apparatuses are used as exposure light sources instead of conventional mercury lamps. For example, a KrF excimer laser apparatus that outputs an ultraviolet laser beam at a wavelength of 248 nm and an ArF excimer laser apparatus that outputs an ultraviolet laser beam at a wavelength of 193 nm are used as gas laser apparatuses for exposure.

As a current exposure technology, immersion exposure has been put into practical use. In the immersion exposure, a gap between an exposure lens in an exposure apparatus and a wafer is filled with fluid, and an apparent wavelength of the exposure light source is shortened by changing the refractive index of the gap. In a case where immersion exposure is performed using an ArF excimer laser apparatus as an exposure light source, a wafer is irradiated with ultraviolet light whose wavelength in water is equivalent to 134 nm. This technique is referred to as “ArF immersion exposure”. ArF immersion exposure is also referred to as “ArF immersion lithography”.

Spectrum line widths of KrF and ArF excimer laser apparatuses in natural oscillation amplitudes are as wide as approximately 350 to 400 pm. This causes a chromatic aberration of a laser beam (ultraviolet light) that is subjected to reduced projection onto a wafer by a projection lens on the side of an exposure device, thus causing a reduction in resolving power. Therefore, a spectrum line width of a laser beam that is outputted from a gas laser apparatus needs to be narrowed to such an extent that the chromatic aberration can be ignored. The spectrum line width is also referred to as “spectrum width”. To narrow the spectrum width, a laser resonator of a gas laser apparatus is provided with a line narrow module having a line narrow element. The line narrow element may be an etalon, a grating, or the like. A laser apparatus whose spectrum width is narrowed in this way is referred to as “narrow band laser apparatus”.

### LIST of DOCUMENTS

### Patent Document

Patent Document 1: U.S. Pat. No. 7,653,112

Patent Document 2: Japanese Patent Application Publication No. 2006-019365

Patent Document 3: Japanese Patent Application Publication No. S62-076582

Patent Document 4: Japanese Patent Application Publication No. H08-018143

Patent Document 5: United States Patent Application Publication No. 2013/0208744

Patent Document 6: Japanese Patent Application Publication No. 2008-522439

Patent Document 7: Japanese Patent Application Publication No. 2003-174221

Patent Document 8: United States Patent Application Publication No. 2003/0072347

Patent Document 9: Japanese Patent Application Publication No. H06-120587

### SUMMARY

A narrow band laser apparatus according to an aspect of the present disclosure may include: a laser chamber; a line narrow module configured to narrow a band width of a laser beam outputted from the laser chamber and return the laser beam to the laser chamber, the line narrow module including a grating; a housing accommodating the line narrow module; three mounts fixed to the housing; and a housing moving device configured to support the housing and the line narrow module by supporting each of the three mounts and move the line narrow module by moving the housing with respect to the laser chamber in a direction substantially perpendicular to a dispersion plane of the grating.

A narrow band laser apparatus according to another aspect of the present disclosure may include: a laser chamber; a line narrow module configured to narrow a band width of a laser beam outputted from the laser chamber and return the laser beam to the laser chamber, the line narrow module including a grating; a housing accommodating the line narrow module; a housing moving device configured to move the line narrow module by moving the housing with respect to the laser chamber in a direction substantially perpendicular to a dispersion plane of the grating; and a grating moving device configured to, in the housing, move the grating with respect to the housing in a direction substantially perpendicular to the dispersion plane of the grating.

A method for positioning a line narrow module according to another aspect of the present disclosure may be a method for positioning a housing with respect to a laser chamber using: the laser chamber; a line narrow module configured to narrow a band width of a laser beam outputted from the laser chamber and return the laser beam to the laser chamber, the line narrow module including a grating; a housing accommodating the line narrow module; a housing moving device configured to support the housing and move the housing in a direction substantially perpendicular to a dispersion plane of the grating; a holding device configured to position the housing with respect to the laser chamber and hold the housing; a first moving mechanism configured to move the housing moving device with respect to the holding device in a direction intersecting a movement direction of the housing by the housing moving device; a cart configured to be able to hold and carry the housing moving device supporting the housing; and a second moving mechanism configured to move the housing moving device supporting the housing with respect to the cart in the direction intersecting the movement direction of the housing by the housing moving device. The method may include: by using the cart, holding and carrying the housing moving device supporting the housing to a vicinity of the holding device; connecting the second moving mechanism to the first moving mechanism; by using the second moving mechanism and the first moving mechanism, moving the housing moving device supporting the housing to the holding device; by using the holding device, positioning and holding the housing with respect to the laser chamber; and by using the first moving mechanism, removing the housing moving device from the housing and the holding device.

### BRIEF DESCRIPTION OF DRAWINGS

Exemplary embodiments of the present disclosure will be described hereinafter with reference to the appended drawings.

FIG. 1A schematically illustrates a configuration of a laser apparatus according to a first embodiment.

FIG. 13 schematically illustrates the configuration of the laser apparatus according to the first embodiment.

FIG. 2A illustrates a configuration and operation of a grating moving device according to the first embodiment.

FIG. 23 illustrates the configuration and operation of the grating moving device according to the first embodiment.

FIG. 2C illustrates the configuration and operation of the grating moving device according to the first embodiment.

FIG. 2D illustrates the configuration and operation of the grating moving device according to the first embodiment.

FIG. 2E illustrates the configuration and operation of the grating moving device according to the first embodiment.

FIG. 3A illustrates a configuration and operation of a grating moving device according to a second embodiment.

FIG. 3B illustrates the configuration and operation of the grating moving device according to the second embodiment.

FIG. 3C illustrates the configuration and operation of the grating moving device according to the second embodiment.

FIG. 3D illustrates the configuration and operation of the grating moving device according to the second embodiment.

FIG. 3E illustrates the configuration and operation of the grating moving device according to the second embodiment.

FIG. 3F illustrates the configuration and operation of the grating moving device according to the second embodiment.

FIG. 4A illustrates configurations and operations of a line narrow module and a housing moving device according to a third embodiment.

FIG. 4B illustrates the configurations and operations of the line narrow module and the housing moving device according to the third embodiment.

FIG. 4C illustrates the configurations and operations of the line narrow module and the housing moving device according to the third embodiment.

FIG. 5A illustrates configurations and operations of a line narrow module and a housing moving device according to a fourth embodiment.

FIG. 5B illustrates the configurations and operations of the line narrow module and the housing moving device according to the fourth embodiment.

FIG. 5C illustrates the configurations and operations of the line narrow module and the housing moving device according to the fourth embodiment.

FIG. 5D illustrates the configurations and operations of the line narrow module and the housing moving device according to the fourth embodiment.

FIG. 5E illustrates the configurations and operations of the line narrow module and the housing moving device according to the fourth embodiment.

FIG. 6A illustrates configurations and operations of a line narrow module and a housing moving device according to a fifth embodiment.

FIG. 6B illustrates the configurations and operations of the line narrow module and the housing moving device according to the fifth embodiment.

FIG. 7A illustrates configurations and operations of a line narrow module and a housing moving device according to a sixth embodiment.

FIG. 7B illustrates the configurations and operations of the line narrow module and the housing moving device according to the sixth embodiment.

FIG. 8A illustrates configurations and operations of a line narrow module and a housing moving device according to a seventh embodiment.

FIG. 8B illustrates the configurations and operations of the line narrow module and the housing moving device according to the seventh embodiment.

FIG. 9A illustrates configurations and operations of a line narrow module and a housing moving device according to an eighth embodiment.

FIG. 9B illustrates the configurations and operations of the line narrow module and the housing moving device according to the eighth embodiment.

FIG. 10 illustrates configurations and operations of a line narrow module and a housing moving device according to a ninth embodiment.

FIG. 11A illustrates a configuration and operation of a line narrow module according to a tenth embodiment.

FIG. 11B illustrates the configuration and operation of the line narrow module according to the tenth embodiment.

FIG. 11C illustrates the configuration and operation of the line narrow module according to the tenth embodiment.

FIG. 11D illustrates the configuration and operation of the line narrow module according to the tenth embodiment.

### DESCRIPTION OF EMBODIMENTS

### Contents

### 1. Outline

### 2. Laser Apparatus Having Grating Moving Device (First Embodiment)

2.1 Laser Chamber

2.2 Line Narrow Module

2.3 Output Coupling Mirror

2.4 Grating Moving Device

### 3. Grating Device Including Wavefront Adjusting Mechanism (Second Embodiment)

### 4. Specific Example of Housing Moving Device (Third Embodiment)

### 5. Laser Apparatus Capable of Moving Housing Moving Device (Fourth Embodiment)

### 6. Housing Moving Device Including Jack Device (Fifth Embodiment)

### 7. Housing Moving Device Including V-direction Shafts (Sixth Embodiment)

### 8. Housing Moving Device Including Springs (Seventh Embodiment)

### 9. Housing Moving Device Including Integrated Rail (Eighth Embodiment)

### 10. Suspending Housing Moving Device (Ninth Embodiment)

### 11. Laser Apparatus Having Grating Moving Device and Housing Moving Device (Tenth Embodiment)

Embodiments of the present disclosure will be described in detail hereinafter with reference to the drawings. The embodiments described hereinafter indicate several examples of the present disclosure, and do not intend to limit contents of the present disclosure. Furthermore, not all of the configurations and operations described in the embodiments are essential in the present disclosure. Note that identical constituent elements will be given identical reference numerals, and redundant descriptions thereof will be omitted.

### 1. Outline

Use of a grating as a line narrow element in a narrow band laser apparatus may cause a surface of the grating to be damaged by a laser beam. For example, the surface of the grating may be oxidized, or an organic substance may adhere to the surface of the grating. Damage to the surface of the grating may result in a decrease in diffraction efficiency. A portion of the surface of the grating that the laser beam did not strike may be damaged less than a portion thereof that the laser beam struck. Accordingly, the grating may be moved so that the laser beam may strike the less-damaged portion. This may make it possible to increase the longevity of the grating and decrease the frequency at which gratings are replaced.

However, the grating, which is used in an excimer laser apparatus, may be considerably large in size and weight when combined with a holder holding the grating. This may make it difficult to move the grating with high accuracy while maintaining a wavefront of diffracted light and maintaining an angle of incidence on the grating.

Further, in a case of moving the whole line narrow module including the grating, the size and the weight may be greater than in a case of moving the grating and the holder. This may make it difficult to move the line narrow module with high accuracy.

According to an aspect of the present disclosure, housing accommodating the line narrow module may be supported at three points, and the housing accommodating the line narrow module may be moved in a direction substantially perpendicular to a dispersion plane of the grating. Further, in the housing, a grating device may be moved in a direction substantially perpendicular to the dispersion plane of the grating.

### 2. Laser Apparatus Having Grating Moving Device (First Embodiment)

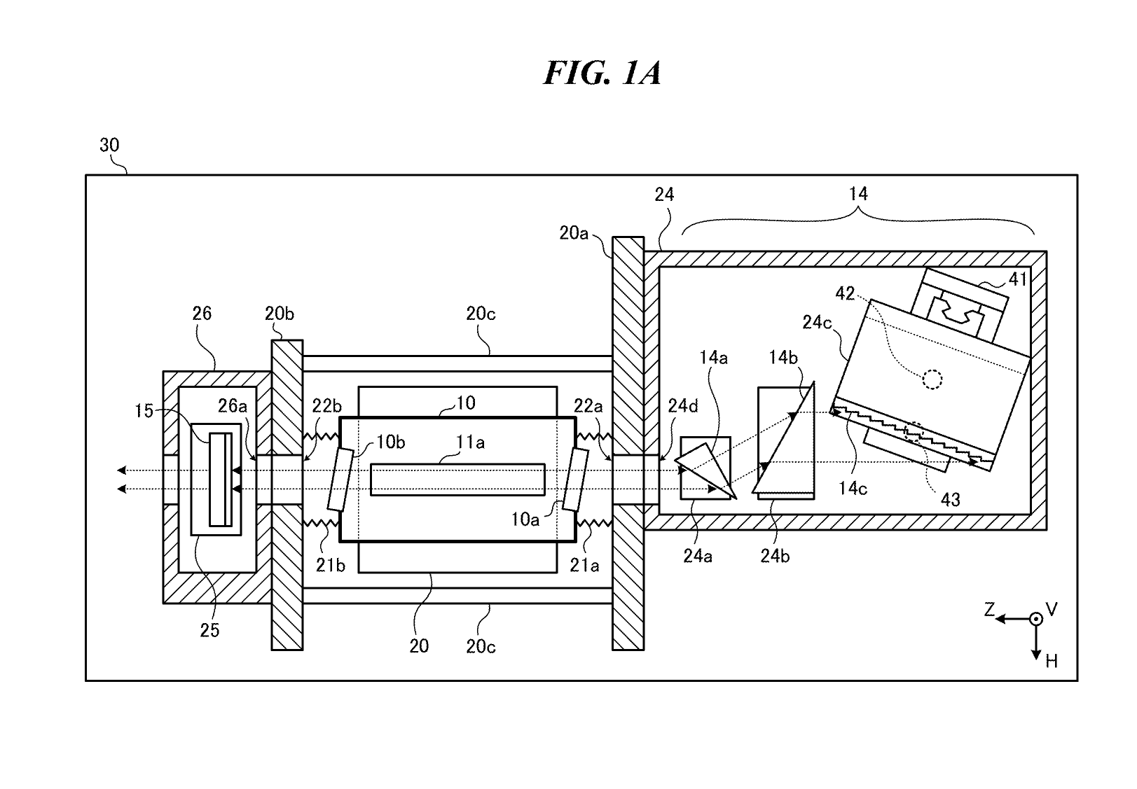

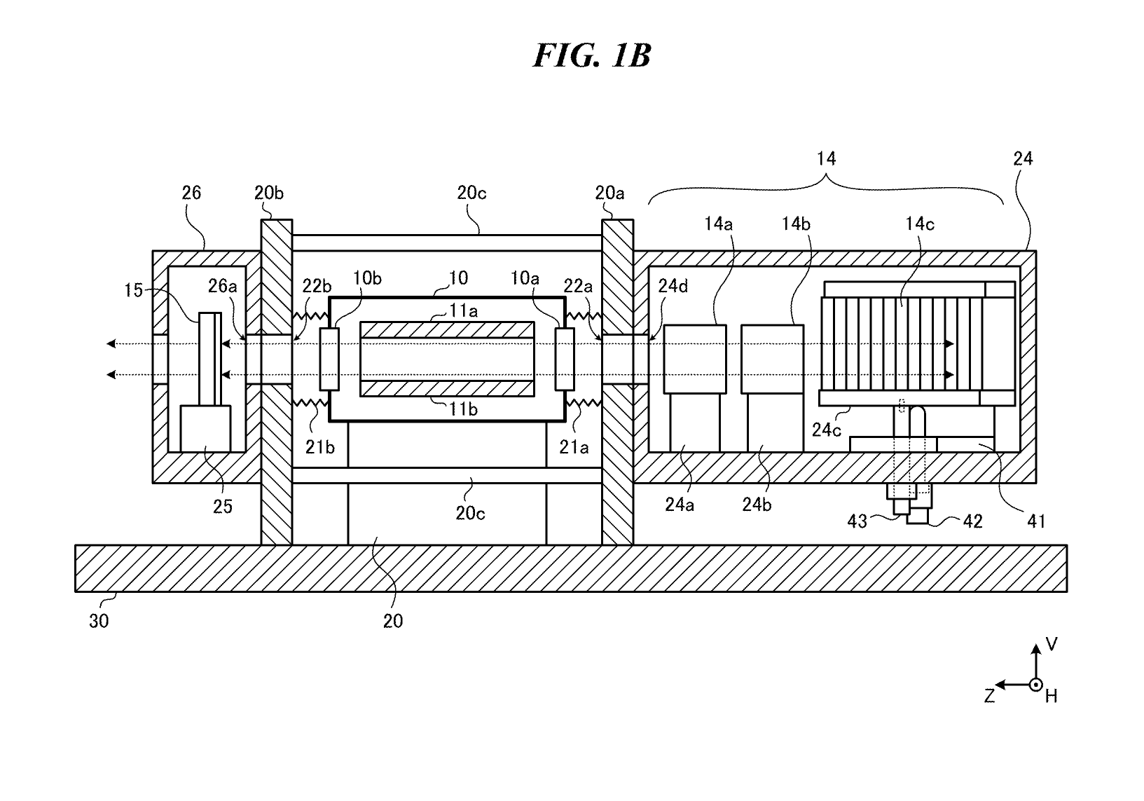

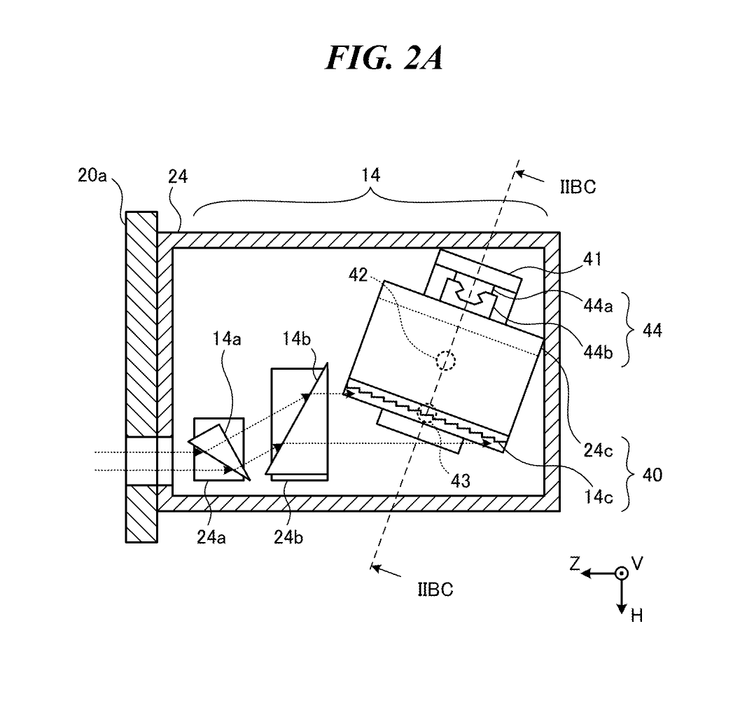

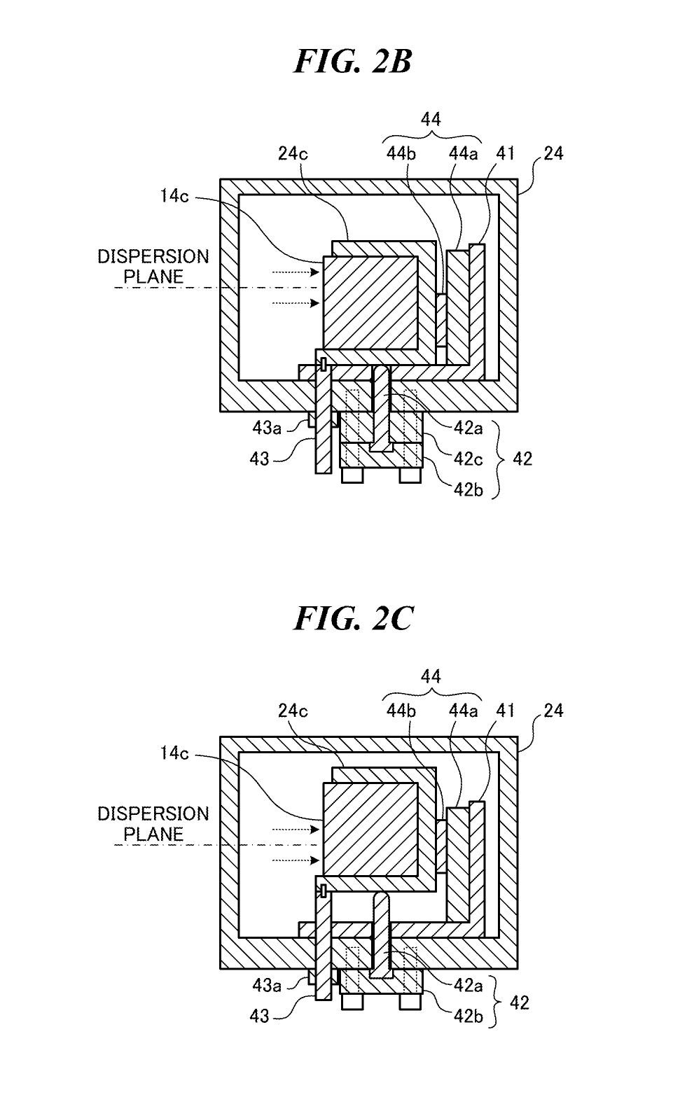

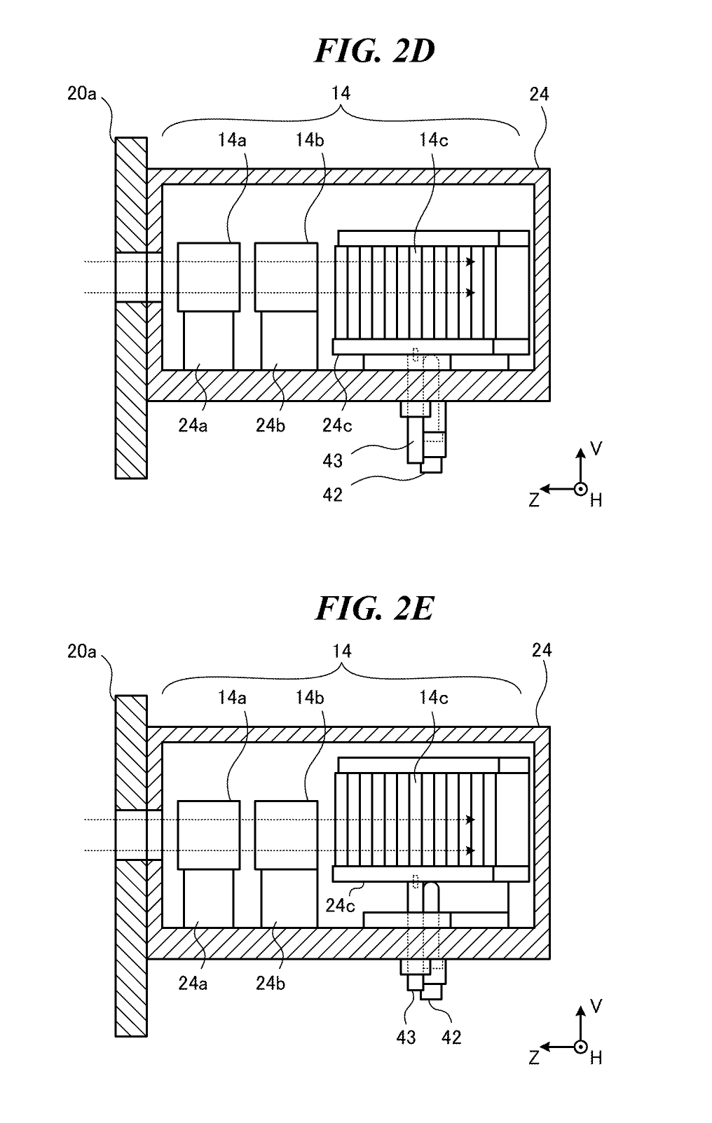

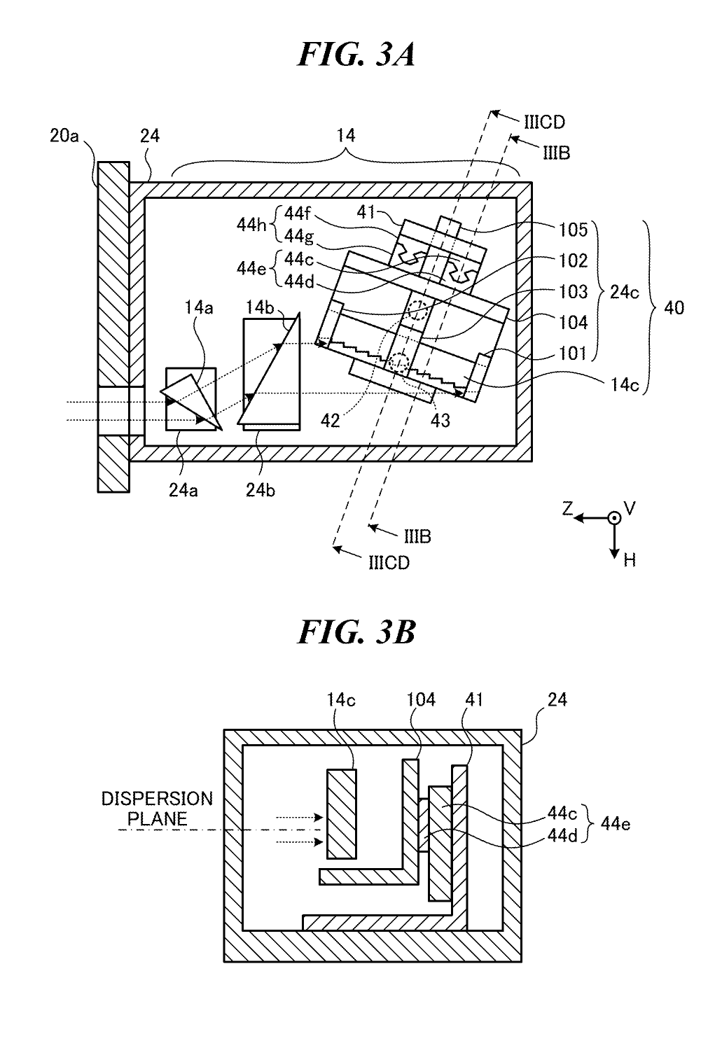

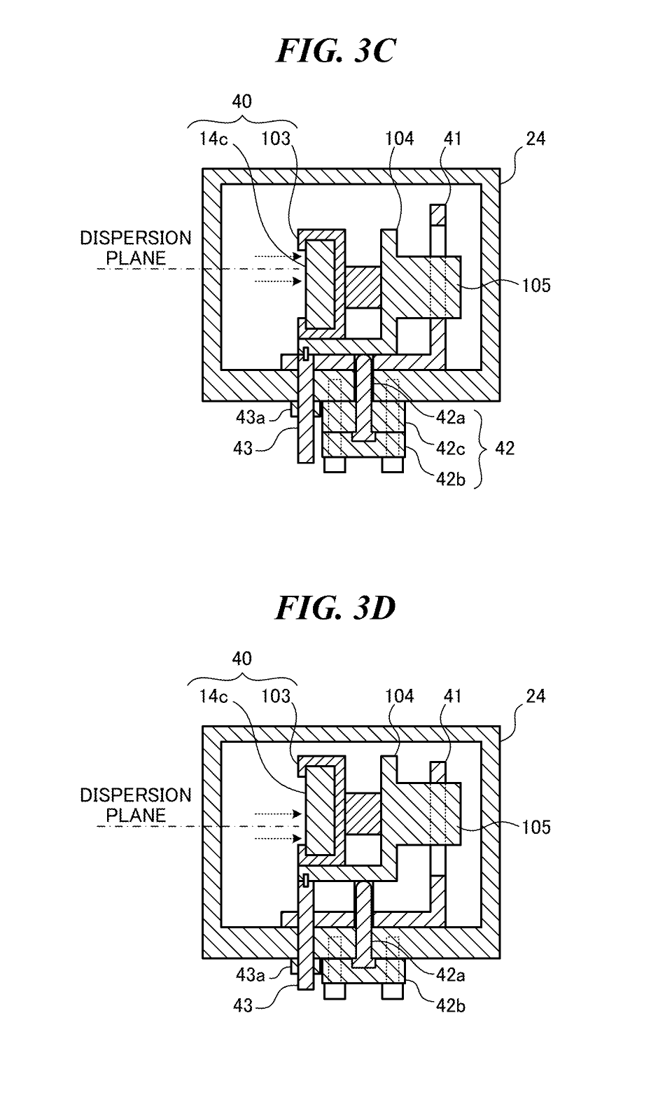

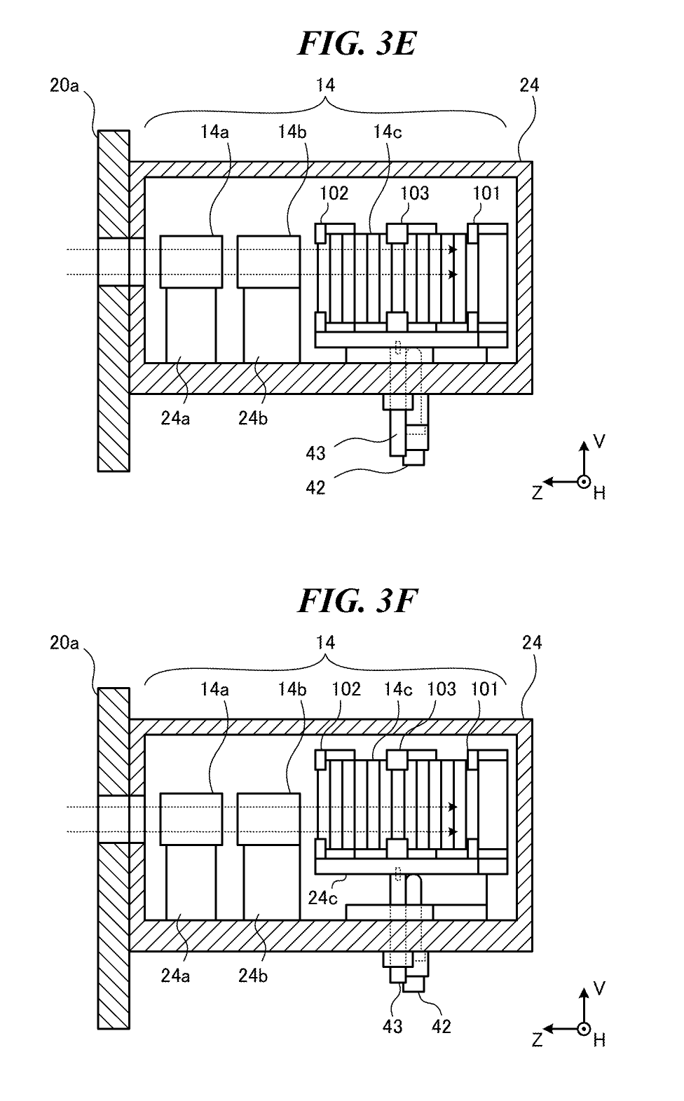

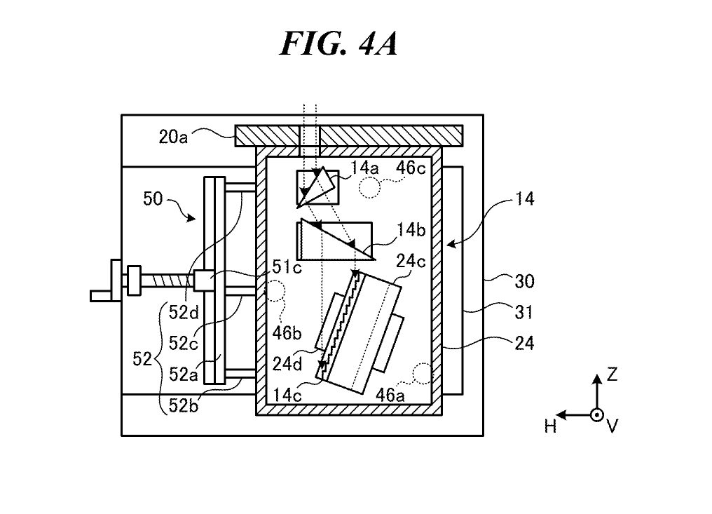

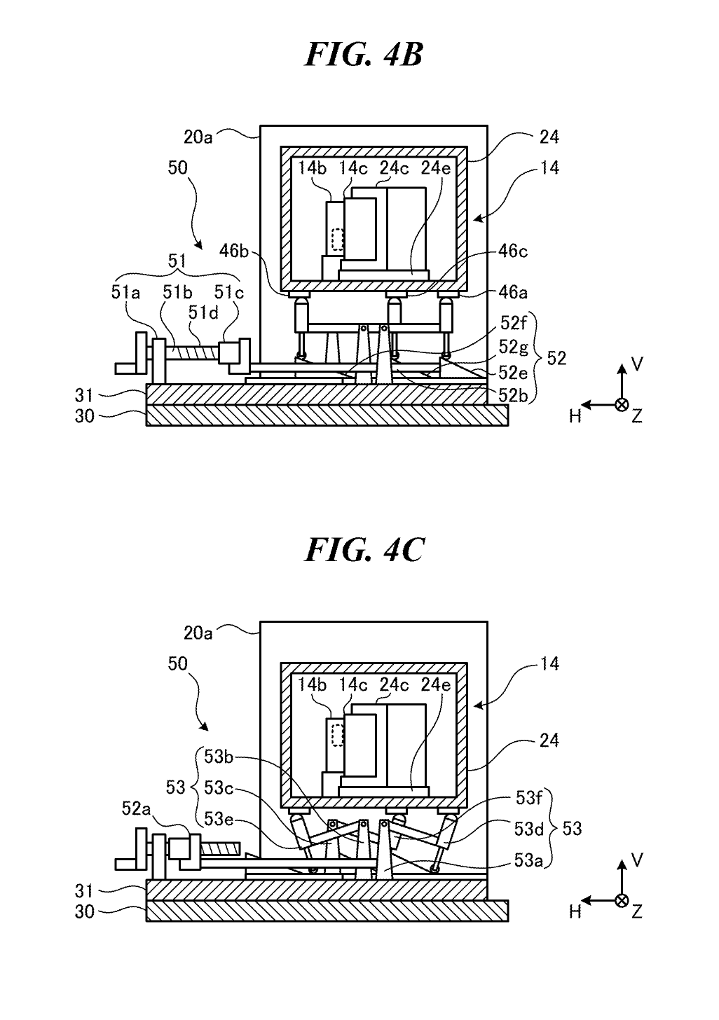

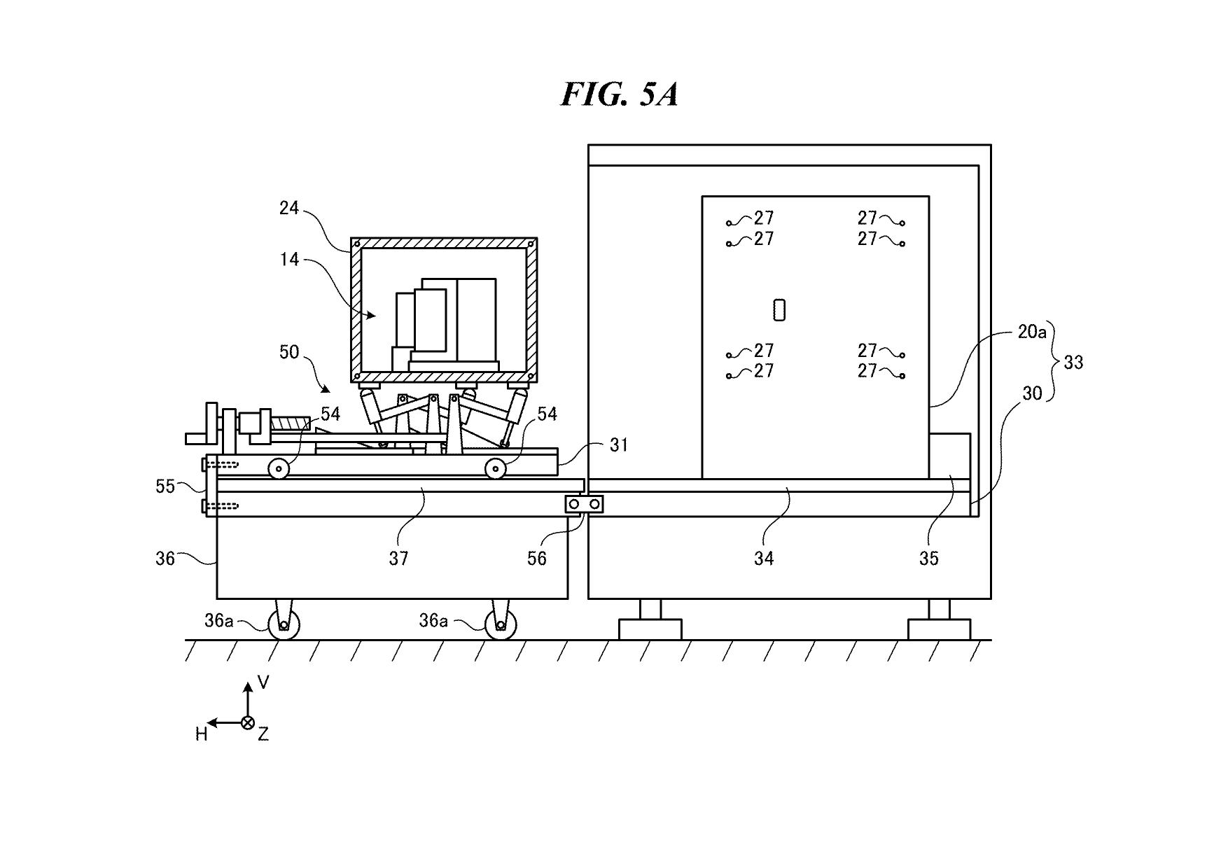

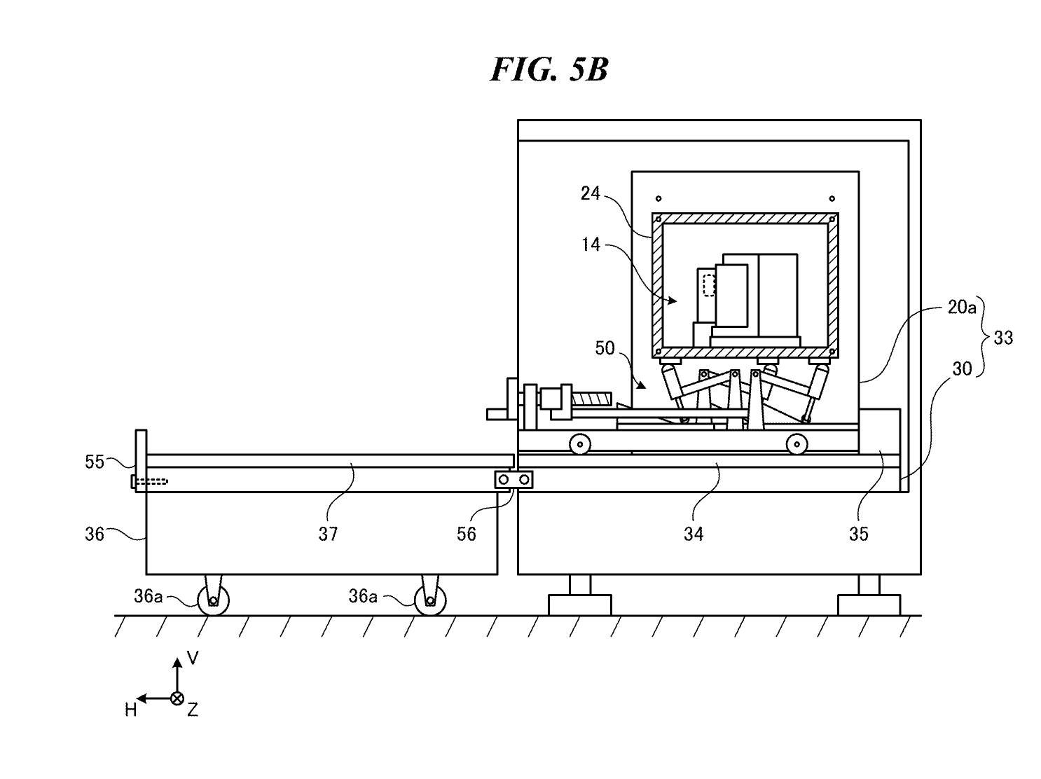

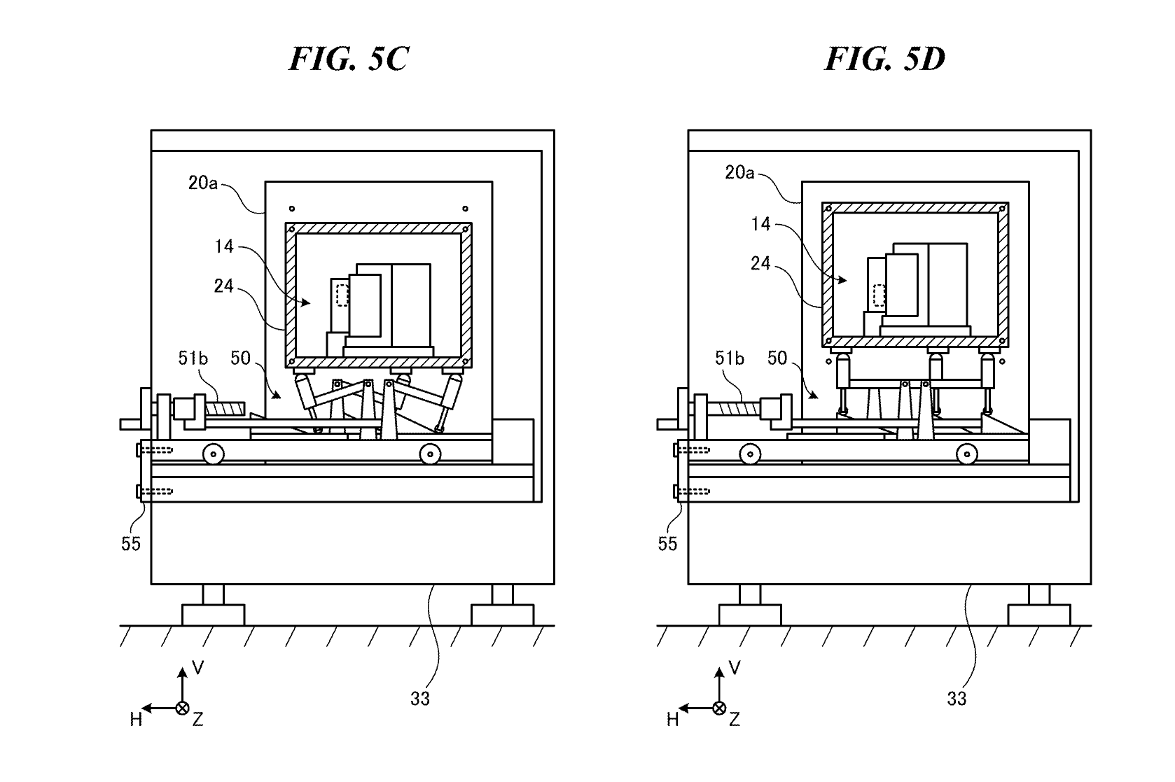

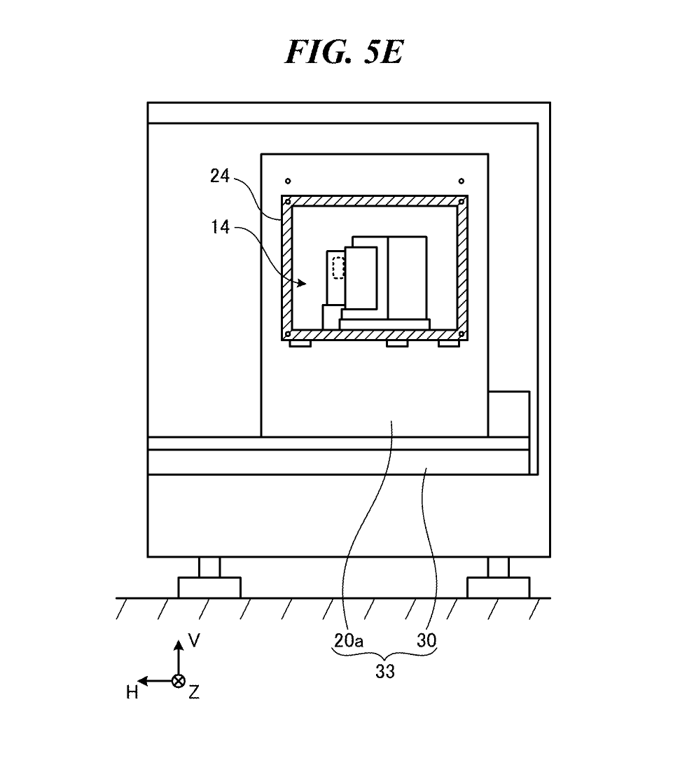

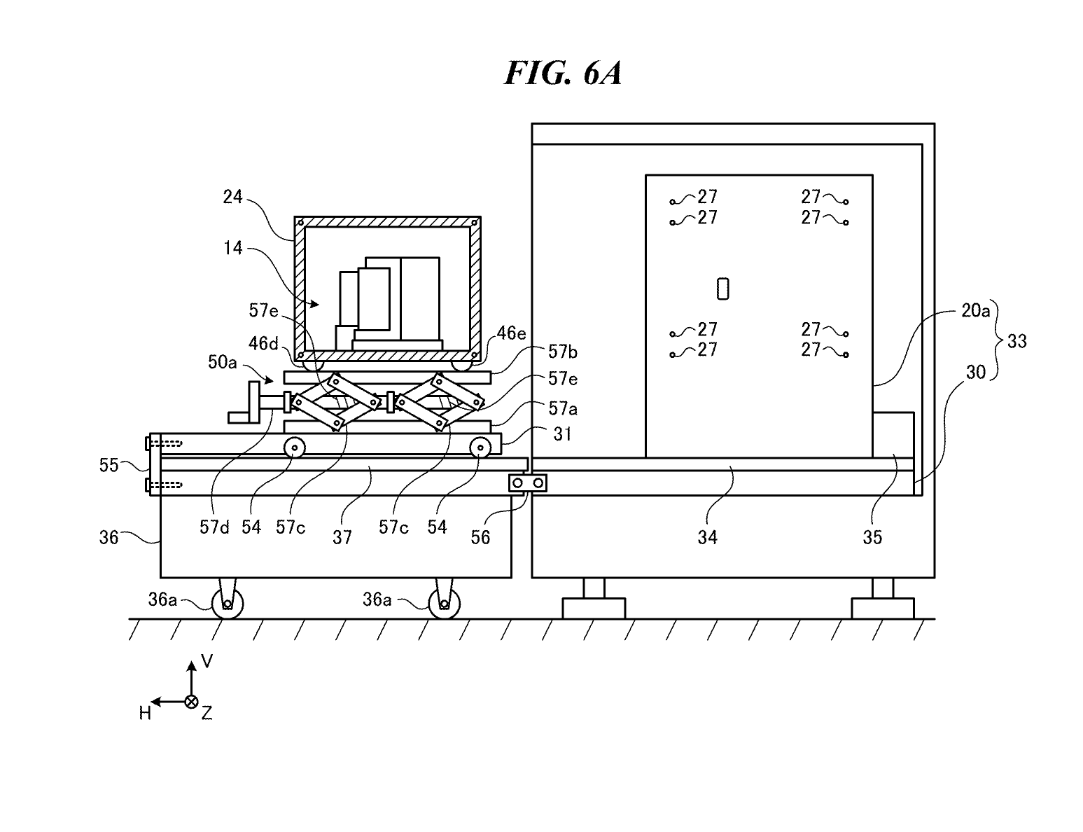

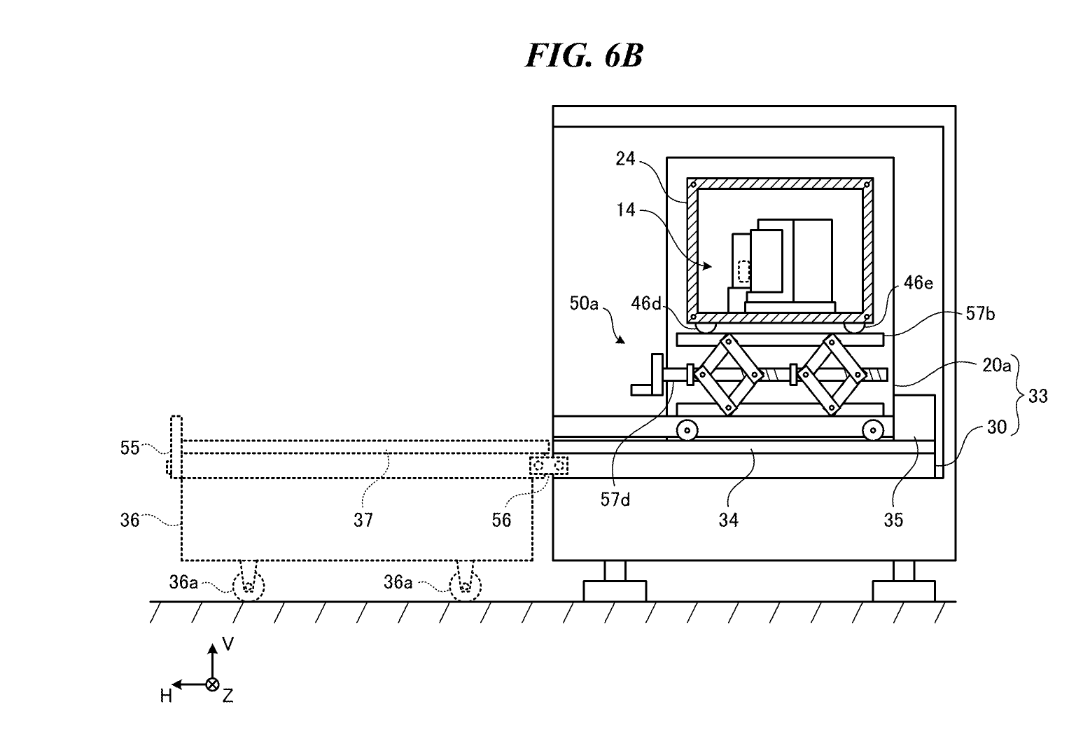

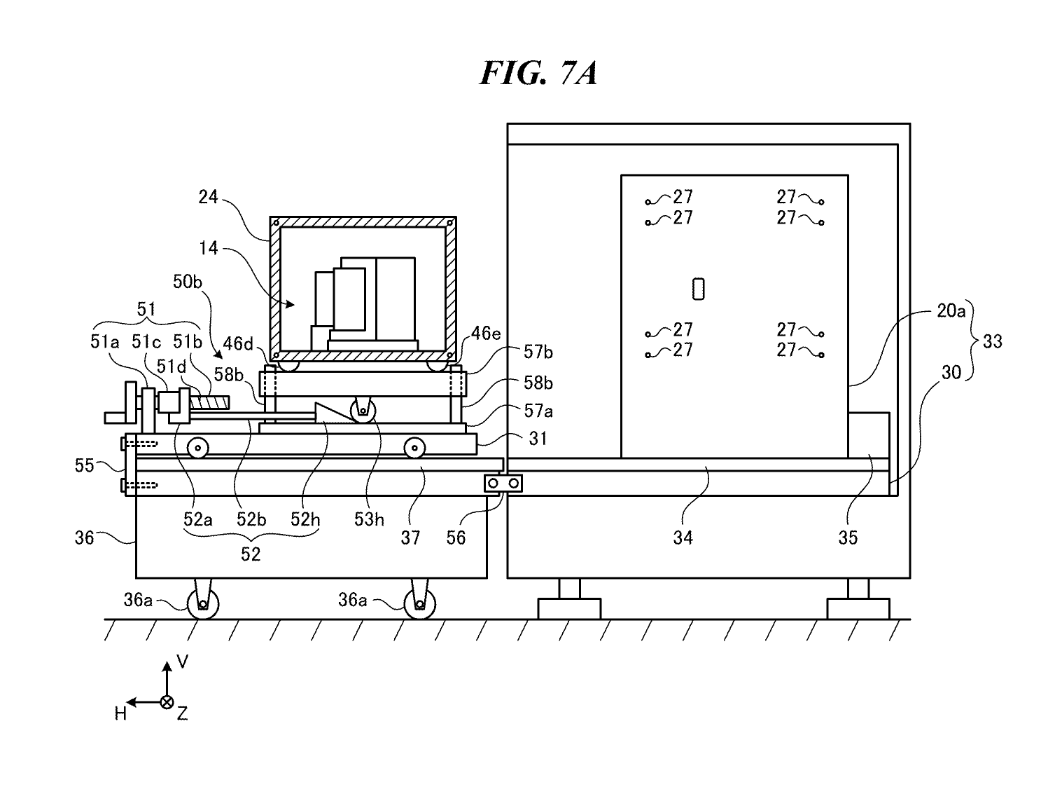

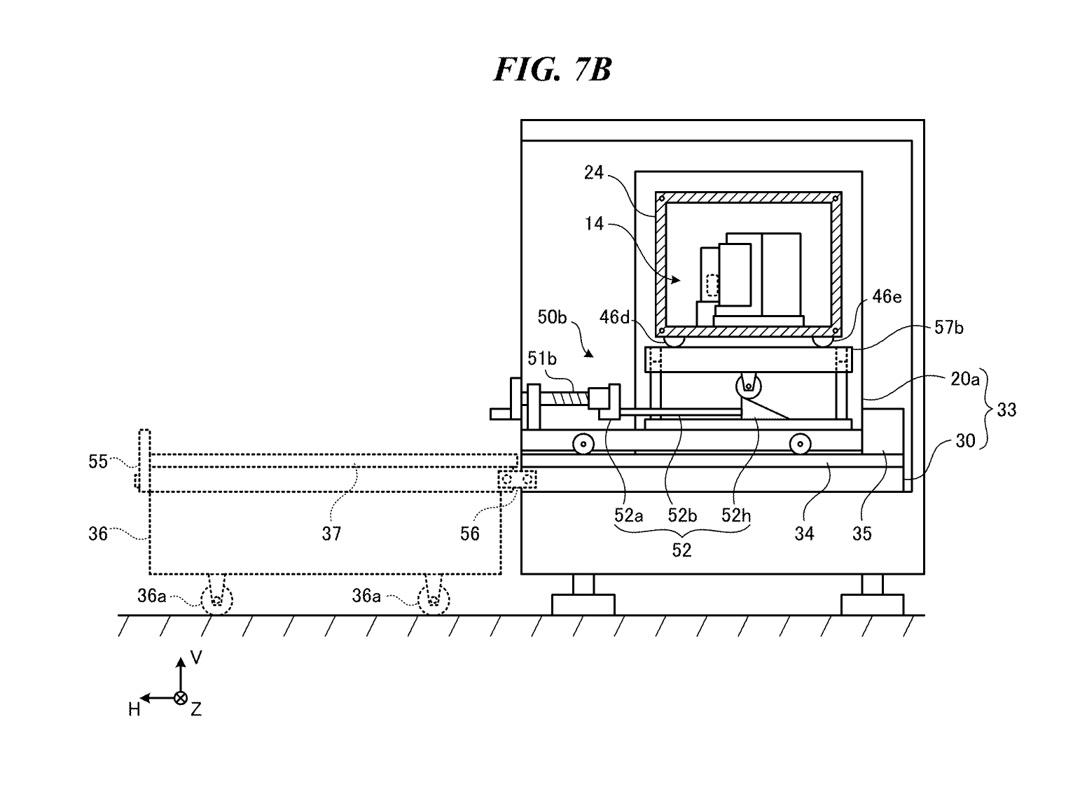

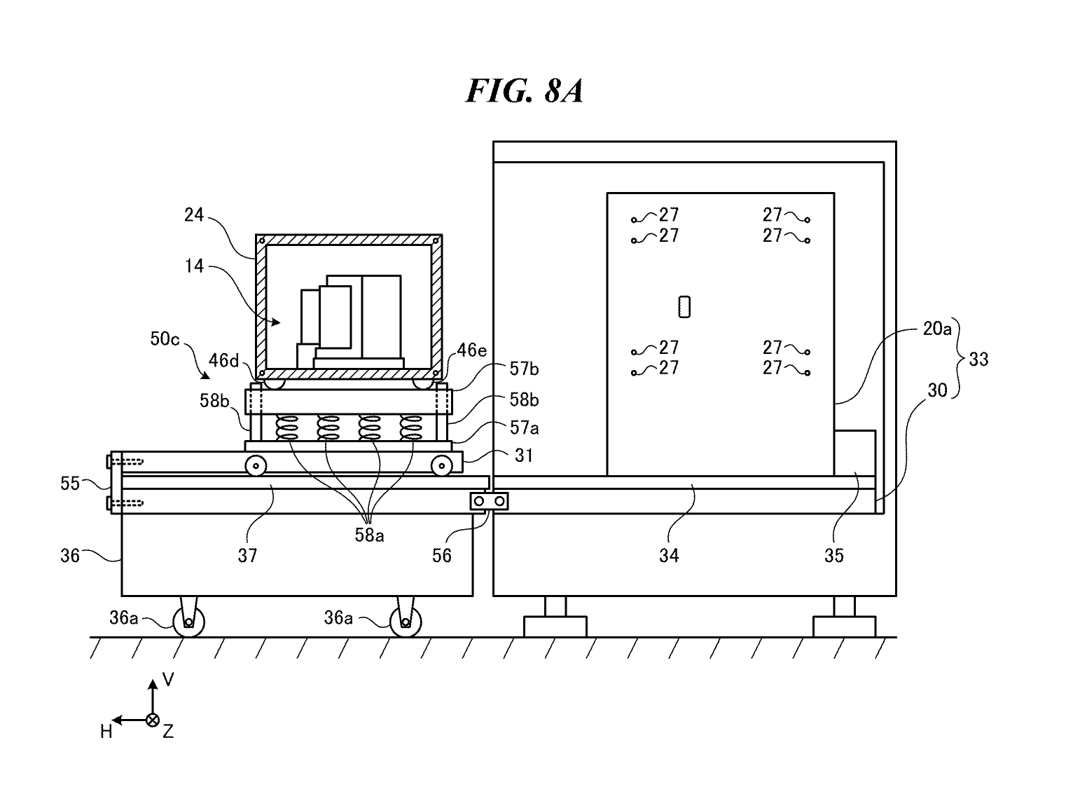

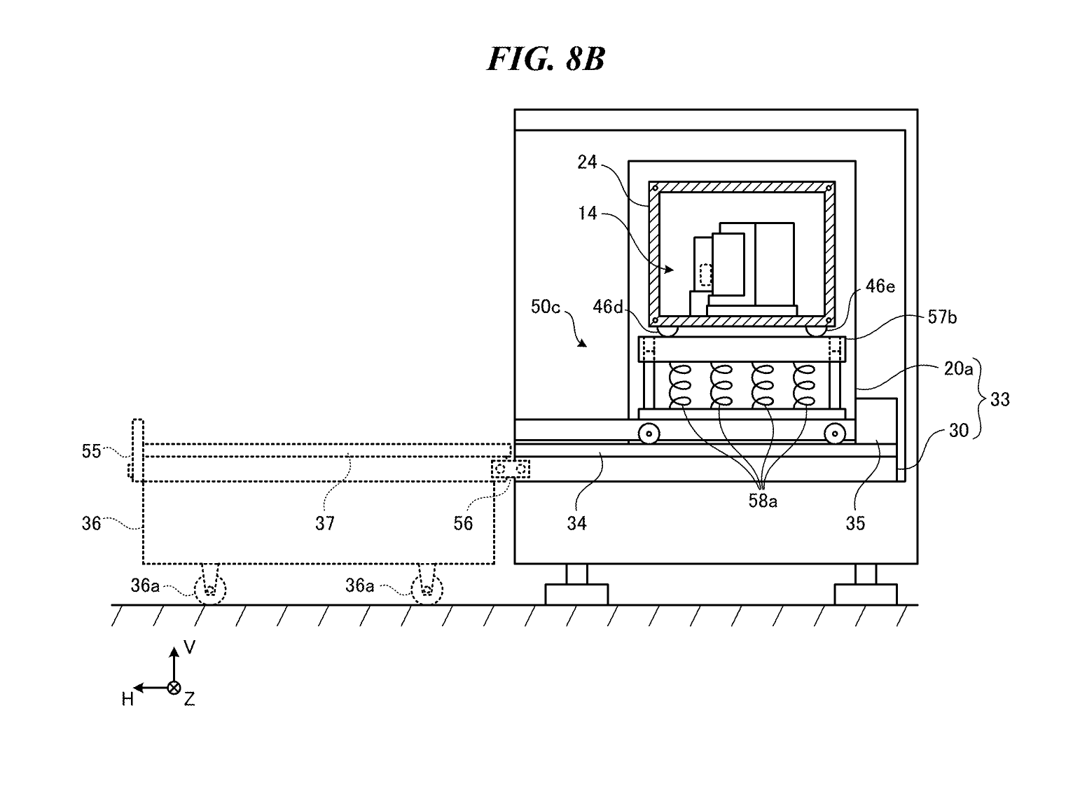

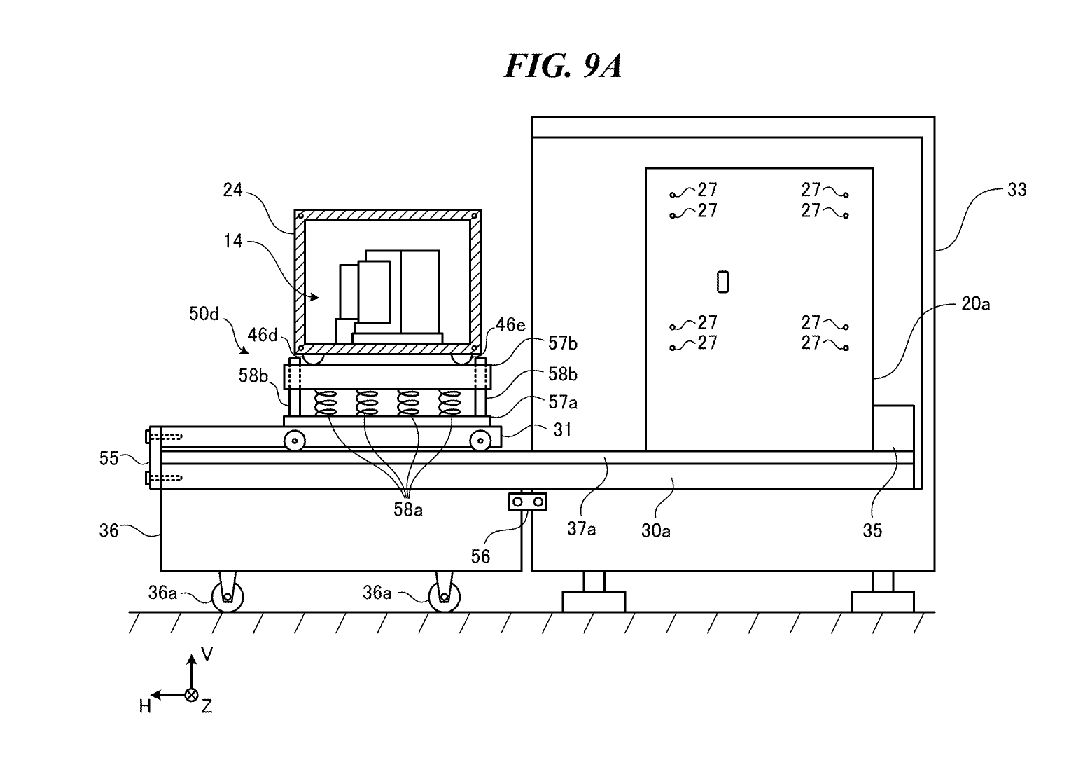

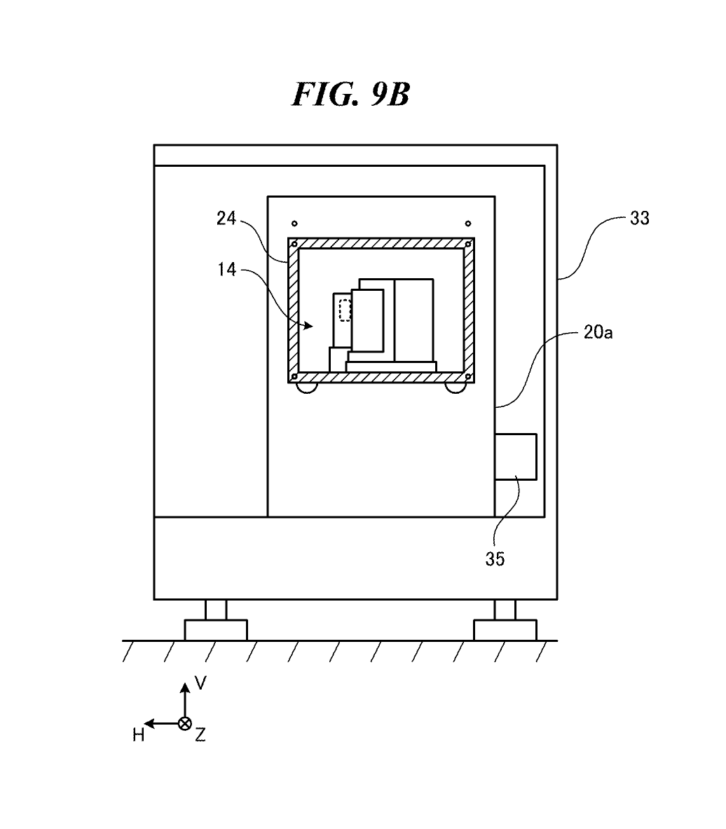

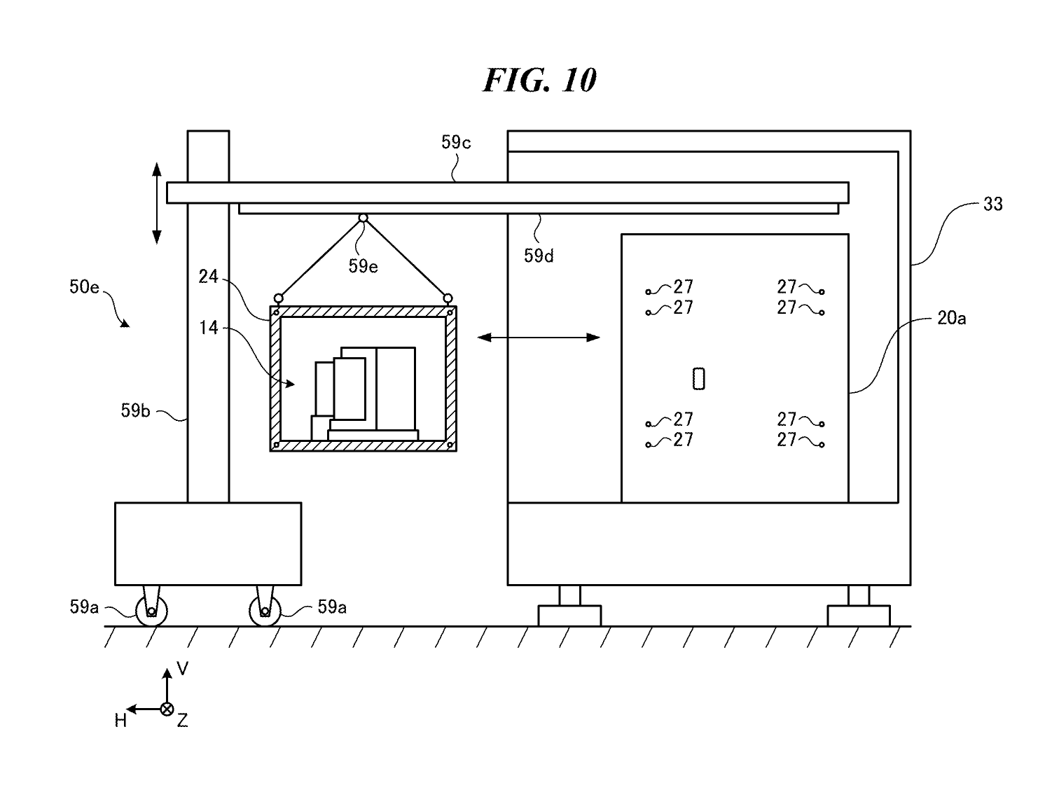

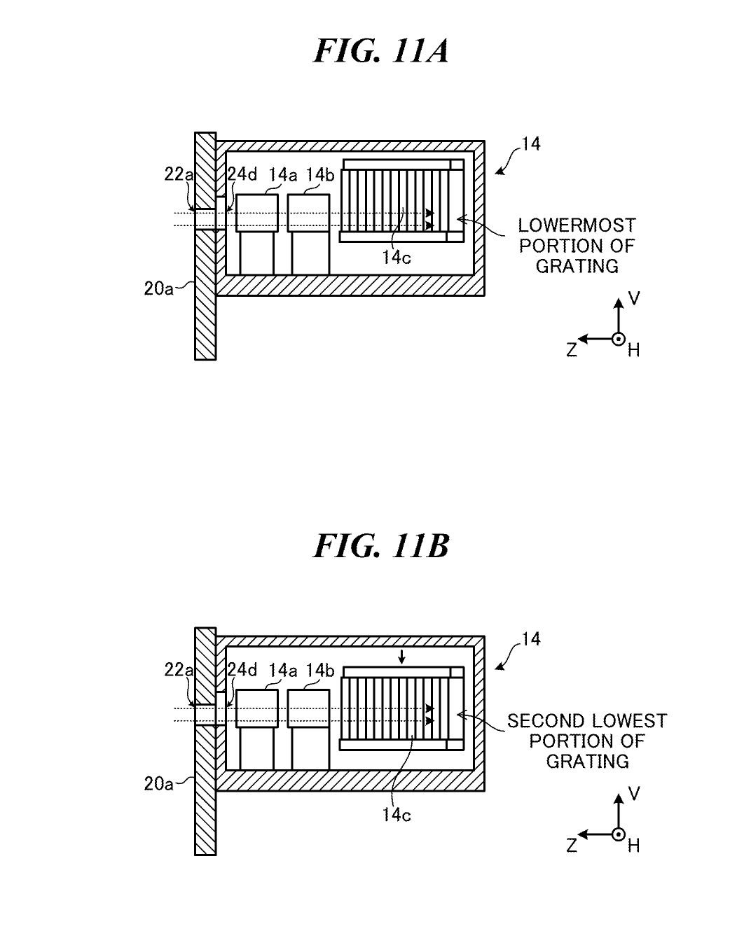

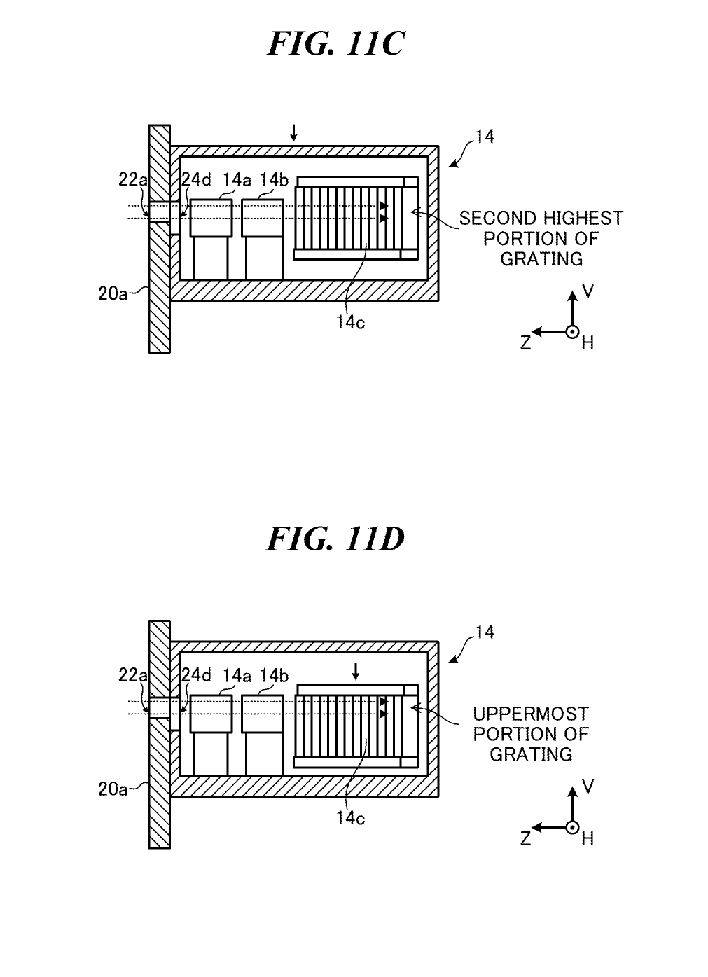

FIGS. 1A and 1B schematically illustrate a configuration of a laser apparatus according to a first embodiment. As shown in FIG. 1A, the laser apparatus may include a laser chamber 10, a pair of discharge electrodes 11a and 11b, a line narrow module 14, and an output coupling mirror 15. The laser apparatus may be a master oscillator configured to perform laser oscillation to output seed light that enters an amplifier (not illustrated).

FIG. 1A illustrates an internal structure of the laser apparatus as viewed from a direction substantially parallel to the direction of discharge between the pair of electrodes 11a and 11b. FIG. 18 illustrates an internal structure of the laser apparatus as viewed from a direction substantially perpendicular to the direction of discharge between the pair of electrodes 11a and 11b and substantially perpendicular to the direction of travel of a laser beam that is outputted from the output coupling mirror 15. The direction of travel of a laser beam that is outputted from the output coupling mirror 15 may be a Z direction. The direction of discharge between the pair of electrodes 11a and 11b may be a V or −V direction. A direction perpendicular to both of these directions may be an H direction. The −V direction may substantially coincide with the direction of gravitational force.

2.1 Laser Chamber

The laser chamber 10 may be a chamber containing a laser gas serving as a laser medium, which contains, for example, argon, neon, fluorine, and the like. Windows 10a and 10b may be provided at both ends of the laser chamber 10.

The laser chamber 10 may be supported by a holder 20. The laser chamber 10 and the holder 20 may be placed between plates 20a and 20b and anchored to a pedestal 30. First ends of three invar rods 20c may be fixed to the plate 20a, and second ends of these three invar rods 20c may be fixed to the plate 20b. The plate 20b may be anchored to the pedestal 30. The plate 20a may be anchored to the pedestal 30 via a linear bush (not illustrated) that is movable in the Z direction.

The plate 20a may have a through-hole 22a formed therein, and the plate 20b may have a through-hole 22b formed therein. An optical path tube 21a may be connected between the plate 20a and the laser chamber 10. The optical path tube 21a may have its first end fixed to the circumference of the through-hole 22a of the plate 20a in a sealed state and its second end fixed to the circumference of the window 10a of the laser chamber 10 in a sealed state. An optical path tube 21b may be connected between the plate 20b and the laser chamber 10. The optical path tube 21b may have a first end fixed to the circumference of the through-hole 22b of the plate 20b in a sealed state and a second end fixed to the circumference of the window 10b of the laser chamber 10 in a sealed state.

The pair of discharge electrodes 11a and 11b may be disposed within the laser chamber 10 as electrodes for exciting the laser medium by discharge. A pulsed high voltage may be applied to the pair of discharge electrodes 11a and 11b from a pulse power module (not illustrated).

When the high voltage is applied between the pair of discharge electrodes 11a and 11b, discharge may occur between the pair of electrodes 11a and 11b. The laser medium within the laser chamber 10 may be excited by the energy of the discharge and may shift to a high energy level. When the excited laser medium shifts back to a low energy level, light depending on the difference between the energy levels may be emitted.

As shown in FIG. 1A, the windows 10a and 10b may be disposed so that the plane of incidence of light on these windows and the HZ plane substantially coincide with each other and the angle of incidence of this light is substantially a Brewster angle. The light produced within the laser chamber 10 may be emitted to the exterior of the laser chamber 10 via the windows 10a and 10b.

2.2 Line Narrow Module

The line narrow module 14 may include two prisms 14a and 14b, a grating 14c, holders 24a to 24c, and a bracket 41. The line narrow module 14 may be accommodated in a housing 24. In the housing 24, the prisms 14a and 14b and the grating 14c may be supported by the holders 24a, 24b, and 24c, respectively. The holder 24c may be supported by the bracket 41. A grating moving device 42 and a shaft member 43 may be attached to the housing 24.

The housing 24 may be supported by the plate 20a. The housing 24 may have a through-hole 24d formed therein. The position of the through-hole 24d in the housing 24 and the position of the through-hole 22a in the plate 20a may substantially overlap each other so that the inside of the optical path tube 21a and the inside of the housing 24 is allowed to communicate with each other. The inside of the optical path tube 21a and the inside of the housing 24 may be filled with an inert gas. The housing 24 may be movable with respect to the laser chamber 10 by a housing moving device (not illustrated in FIGS. 1A and 1B). The housing moving device will be described later.

The prisms 14a and 14b may expand the H-direction beam width of the light emitted via the window 10a of the laser chamber 10. The prisms 14a and 14b may then allow that light to enter the grating 14c. Further, the prisms 14a and 14b may reduce the H-direction beam width of the light reflected by the grating 14c. The prisms 14a and 14b may then allow that light to return to the discharge region of the laser chamber 10 via the window 10a.

The grating 14c may have a large number of grooves formed at predetermined intervals in a surface thereof. Surface material of the grooves may be highly-reflective. The grooves may for example be right triangular grooves. Light travelling from the prisms 14a and 14b and being incident on the grating 14c may be reflected by these grooves and diffracted in a direction corresponding to the wavelength of the light. The grating 14c may be disposed at a Littrow arrangement so that the angle of incidence of the light travelling from the prisms 14a and 14b and being incident on the grating 14c and the angle of diffraction of diffracted light of a desired wavelength substantially coincide with each other. This may allow light near the desired wavelength to be returned to the laser chamber 10 via the prisms 14a and 14b.

2.3 Output Coupling Mirror

The output coupling mirror 15 may be accommodated in a housing 26. The output coupling mirror 15 may be supported by a holder 25 in the housing 26.

The housing 26 may be supported by the plate 20b. The housing 26 may have a through-hole 26a formed therein. The position of the through-hole 26a in the housing 26 and the position of the through-hole 22b in the plate 20b may overlap each other so that the inside of the optical path tube 21b and the inside of the housing 26 is allowed to communicate with each other. The optical path tube 21b and the housing 26 may be filled with an inert gas.

The surface of the output coupling mirror 15 may be coated with a partially-reflective film. Accordingly, the output coupling mirror 15 may allow some of the light outputted via the window 10b of the laser chamber 10 to pass through, thus outputting that light, and may reflect the remainder of the light to return the reflected light to the interior of the laser chamber 10.

The line narrow module 14 and the output coupling mirror 15 may constitute an optical resonator. The light emitted from the laser chamber 10 may travel back and forth between the line narrow module 14 and the output coupling mirror 15, and may be amplified and subjected to laser oscillation each time it passes through a laser gain space between the discharge electrodes 11a and 11b. The laser beam may be subjected to line narrowing every time it is returned by the line narrow module 14. Furthermore, a polarization component in the H direction may be selected by the aforementioned disposition of the windows 10a and 10b. The laser beam thus amplified may be outputted from the output coupling mirror 15.

2.4 Grating Moving Device

FIGS. 2A to 2E illustrate a configuration and operation of the grating moving device according to the first embodiment. FIGS. 2A to 2E omit to illustrate the laser chamber 10, the output coupling mirror 15, and the like. FIGS. 2A to 2E also omit to illustrate the housing moving device, which will be described later. FIG. 2A is a diagram as viewed from a direction substantially perpendicular to the dispersion plane of the grating. FIGS. 2B and 2C are cross-sectional views taken along line IIBC-IIBC in FIG. 2A. FIGS. 2D and 2E are diagrams as viewed from a direction substantially parallel to the dispersion plane of the grating and substantially perpendicular to the direction of travel of a laser beam that is outputted from the output coupling mirror 15.

The holder 24c may hold the grating 14c in such a way as to cover the lower, back, and upper surfaces of the grating 14c. The grating 14c and the holder 24c may constitute a grating device 40.

The grating device 40 may be held by the bracket 41 via a linear guide 44. The linear guide 44 may include a rail unit 44a fixed to the bracket 41 and a moving unit 44b fixed to the holder 24c. The moving unit 44b may be movable in the V or −V direction along the rail unit 44a.

The shaft member 43 may penetrate the bottom of the housing 24 and the bracket 41 in the V direction and be fixed via a linear bush (not illustrated). The shaft member 43 may have its upper end connected to the bottom surface of the holder 24c. The shaft member 43 may thus define an axis of rotation of the grating device 40 and the bracket 41. The axis of rotation of the grating device 40 and the bracket 41 may substantially coincide with the center position of the surface of the grating 14c. By the grating device 40 and the bracket 41 rotating in a substantially integrated manner, an adjustment may be made so that the angle of incidence of the light being incident on the grating 14c and the angle of diffraction of the diffracted light of the desired wavelength substantially coincide with each other. The rotation of the grating device 40 and the bracket 41 may be locked by a shaft lock 43a.

The grating moving device 42 may include a positioning pole 42a and a fixing member 42b. The positioning pole 42a may penetrate the bottom of the housing 24 and the bracket 41. The diameter of the through-hole via which the positioning pole 42a penetrates the bracket 41 may be slightly larger than the diameter of the positioning pole 42a so that the bracket 41 may rotate on the shaft member 43. The diameter of the through-hole in the bottom of the housing 24 may be such that the positioning pole 42a is movable in the V direction and hardly tilts. For example, a linear bush (not illustrated) may be provided in the through-hole of the housing 24 so that the positioning pole 42a may be made movable in the V direction via the linear bush.

The positioning pole 42a may have its lower end supported by the fixing member 42b. The fixing member 42b may be fixed to the bottom surface of the housing 24 by bolts. As shown in FIG. 2B, a spacer 42c may be interposed between the bottom surface of the housing 24 and the fixing member 42b. The position of the positioning pole 42a may be adjusted according to the thickness of the spacer 42c or the presence or absence of the spacer 42c.

The upper end of the positioning pole 42a may have a semispherical shape. The upper end of the positioning pole 42a may be in contact with the bottom surface of the holder 24c. The upper end of the positioning pole 42a may support the holder 24c by the bottom surface. The position of the grating device 40 in the V or −V direction may be adjusted according to the position of the positioning pole 42a. When the grating device 40 moves in the V or −V direction, the shaft member 43 may move together with the grating device 40.

The rotation of the grating device 40 on the shaft member 43 may cause the upper end of the positioning pole 42a to make contact with the bottom surface of the holder 24c at a slightly different position. However, it is preferable that the upper end of the positioning pole 42a support the grating device 40 near the center of gravity from the −V direction.

The width of the grating 14c in the V direction may be equal to or greater than double the beam width of the laser beam in the V direction. The distance that the grating moving device 42 moves the grating device 40 may be equal to or greater than the beam width of the laser beam in the V direction. Where the grating moving device 42 moves the grating device 40 in the V or −V direction, the position of the laser beam in the V direction does not need to change. Therefore, as shown in FIGS. 2B and 2D, when the grating device 40 is located in a lower position, the upper half of the grating 14c may be used. As shown in FIGS. 2C and 2E, when the grating device 40 is located in a higher position, the lower half of the grating 14c may be used. Therefore, for example, if the upper half of the grating 14c has deteriorated, the grating moving device 42 may be used to switch to using the lower half of the grating 14c.

According to the present embodiment, since the positioning pole 42a supports the grating device 40 at or near the center of gravity in the V direction, the stress in the grating device 40, the linear guide 44, the shaft member 43, and the like may be reduced. Therefore, the grating moving device 42 can stably support the grating device 40 and may suppress a misalignment of the grating 14c even when moving the grating device 40 in the V or −V direction.

In the foregoing description, a case has been described where the grating moving device 42 includes the positioning pole 42a. However, the present disclosure is not limited to this. The positioning pole 42a may be replaced by an automatic micrometer. Further, although the prisms 14a and 14b have been used as beam expanders, this does not imply any limitation. Other types of beam expanders may be used.

### 3. Grating Device Including Wavefront Adjusting Mechanism (Second Embodiment)

FIGS. 3A to 3F illustrate a configuration and operation of a grating moving device according to a second embodiment. FIGS. 3A to 3F omit to illustrate the laser chamber 10, the output coupling mirror 15, and the like. FIG. 3A is a diagram as viewed from a direction substantially perpendicular to the dispersion plane of the grating. FIG. 3B is a cross-sectional view taken along line IIIB-IIIB in FIG. 3A. FIGS. 3C and 3D are cross-sectional views taken along line IIICD-IIICD in FIG. 3A. FIGS. 3E and 3F are diagrams as viewed from a direction substantially parallel to the dispersion plane of the grating and substantially perpendicular to the direction of travel of a laser beam that is outputted from the output coupling mirror 15.

In the laser apparatus according to the second embodiment, the holder 24c of the grating device 40 may include a wavefront adjusting mechanism. The wavefront adjusting mechanism may include end fixing units 101 and 102, a movable unit 103, a holding unit 104, and a driving unit 105.

A first end of the grating 14c in FIG. 3A may be fixed by being clamped by the end fixing unit 101. A second end of the grating 14c in FIG. 3A may be fixed by being clamped by the end fixing unit 102. A central portion of the grating 14c in FIG. 3A may be held by being clamped by the movable unit 103. The movable unit 103 may be able to be pushed and pulled by the driving unit 105. The end fixing units 101 and 102 and the movable unit 103 may be held by the holding unit 104. The driving unit 105 may be integrated with the holding unit 104. The curvature of the grating 14c may be able to be changed by pushing and pulling the central portion of the grating 14c with the movable unit 103 and the driving unit 105. The wavefront of the diffracted light from the grating 14c may be adjusted by changing the curvature of the grating 14c.

In the second embodiment, linear guides 44e and 44h may be disposed on both sides of the driving unit 105, which pushes and pulls the movable unit 103. The linear guide 44e may include a rail unit 44c fixed to the bracket 41 and a moving unit 44d fixed to the holding unit 104. The linear guide 44h may include a rail unit 44f fixed to the bracket 41 and a moving unit 44g fixed to the holding unit 104.

Further, since the movable unit 103 and the driving unit 105 are disposed on a back side of the grating 14c, the center of gravity of the grating device 40 according to the second embodiment may be slightly closer to the linear guides than the center of gravity of the grating device 40 according to the first embodiment. Therefore, the position of the positioning pole 42a in the second embodiment may be slightly closer to the linear guides than the position of the positioning pole 42a in the first embodiment.

In other respects, the second embodiment may be identical to the first embodiment.

As with the first embodiment, the second embodiment may make it possible to stably support the grating device and, even when moving the grating device 40 in the V or −V direction, suppress a misalignment of the grating.

The wavefront adjusting mechanism described in the second embodiment is a mere example and, as such, may be replaced by another wavefront adjusting mechanism.

### 4. Specific Example of Housing Moving Device (Third Embodiment)

FIGS. 4A to 4C illustrate configurations and operations of a line narrow module and a housing moving device according to a third embodiment. FIGS. 4A to 4C omit to illustrate the laser chamber 10, the output coupling mirror 15, or the like. FIG. 4A is a diagram as viewed from a direction substantially perpendicular to the dispersion plane of the grating. FIGS. 4B and 4C are diagrams as viewed from a direction substantially parallel to the direction of travel of a laser beam that is outputted from the output coupling mirror 15.

The laser apparatus according to the third embodiment may include a housing moving device 50 configured to cause the housing 24 accommodating the line narrow module 14 including the prisms 14a and 14b, the grating 14c, and the like to move with respect to the laser chamber 10. The widths of the prisms 14a and 14b in the V direction may be equal to or greater than double the beam width of the laser beam in the V direction. The width of the grating 14c in the V direction may be equal to or greater than double the beam width of the laser beam in the V direction. The grating device described in the first and second embodiments does not need to be included. The grating 14c may be held by the holder 24c, and the holder 24c may be fixed to the housing 24 by a fixing member 24e.

Three mounts 46a to 46c may be fixed to the lower surface of the housing 24. The mounts 46a to 46c may have their respective concave shaped lower surfaces. The line narrow module 14 may be supported by these mounts 46a to 46c from below. When viewed from the V direction, the line narrow module 14 may have its center of gravity overlapped, in the V direction, with a position inside a triangle having its vertices at the positions of the mounts 46a to 46c.

The housing moving device 50 may include a cam feeder 51, a linear cam 52, and an elevator 53. The cam feeder 51, the linear cam 52, and the elevator 53 may be located on a plate 31 anchored to the pedestal 30.

As shown in FIG. 4B, the cam feeder 51 may include a rod supporting unit 51a, a rotating rod 51b, and a linear motion unit 51c. The rod supporting unit 51a may be fixed to the plate 31. The rotating rod 51b may be supported by the rod supporting unit 51a so that movement of the rotating rod 51b in a longitudinal direction is restricted. The rotating rod 51b may be rotatable on an axis of rotation extending in the longitudinal direction. The rotating rod 51b may have a feed screw portion 51d. The feed screw portion 51d may be a portion where a male screw has been formed on an outer circumferential surface of the rotating rod 51b. The linear motion unit 51c may have a female screw formed in an inner circumferential surface thereof, and the feed screw portion 51d may be screwed into the linear motion unit 51c. The linear motion unit 51c may be fixed to a bracket 52a of the linear cam 52 so that rotation of the linear motion unit 51c may be restricted. The linear motion unit 51c may reciprocate in the longitudinal direction of the rotating rod 51b as the rotating rod 51b having the feed screw portion 51d rotates.

As shown in FIGS. 4A and 4B, the linear cam 52 may include the bracket 52a, connecting poles 52b, 52c, and 52d, and slope units 52e, 52f, and 52g. The bracket 52a may be fixed to the linear motion unit 51c of the cam feeder 51. The connecting poles 52b, 52c, and 52d may have their first ends fixed to the bracket 52a. The connecting poles 52b, 52c, and 52d may have their second ends fixed to the slope units 52e, 52f, and 52g, respectively. The slope units 52e, 52f, and 52g may each have an inclined surface, which becomes higher along the H direction and becomes lower along the −H direction. The linear cam 52 may reciprocate in the H and −H directions as the linear motion unit 51c of the cam feeder 51 reciprocates.

As shown in FIG. 4C, the elevator 53 may include rigid supports 53a, 53b, and 53c, and swing levers 53d, 53e, and 53f. The rigid supports 53a, 53b, and 53c may be fixed to the plate 31. The swing levers 53d, 53e, and 53f may have their first ends supported by the rigid supports 53a, 53b, and 53c, respectively, so that the swing levers 53d, 53e, and 53f may shake around their respective first ends. The swing levers 53d, 53e, and 53f may have, at their second ends, supporting units which have semispherical upper surfaces and support the mounts 46a, 46b, and 45c, respectively. The swing levers 53d, 53e, and 53f may also have, at their second ends, cam follower units which have wheels at their bottoms and move upward and downward along their inclined surfaces of the slope units 52e, 52f, and 52g, respectively. As the linear cam 52 reciprocates, the swing levers 53d, 53e, and 53f may shake upward and downward to move the line narrow module 14 upward and downward.

The distance that the housing moving device 50 moves the housing 24 may be equal to or greater than the beam width of the laser beam in the V direction. Where the housing moving device 50 moves the housing 24 in the V or −V direction, the position of the laser beam in the V direction does not need to change. Therefore, as shown in FIG. 4B, if the housing 24 accommodating the line narrow module 14 is located in a lower position, the upper half of every one of the prisms 14a and 14b and the grating 14c may be used. As shown in FIG. 4C, if the housing 24 accommodating the line narrow module 14 is located in a higher position, the lower half of every one of the prisms 14a and 14b and the grating 14c may be used. The grating 14c is not necessarily the only optical element that is damaged by the laser beam, and the prisms 14a and 14b may be damaged, too. For example, if the upper half of every or any one of the prisms 14a and 14b and the grating 14c has deteriorated, the housing moving device 50 may be used to switch to using the lower half of every one of the prisms 14a and 14b and the grating 14c.

According to the third embodiment, the prisms 14a and 14b, as well as the grating 14c, may move. This may make it possible to increase the longevity of the prisms 14a and 14b and decrease the frequency at which prisms 14a and 14b are replaced.

Further, according to the third embodiment, the housing 24 accommodating the line narrow module 14 is supported in such an arrangement that the center of gravity of the housing 24 accommodating the line narrow module 14 is overlapped, in the V direction, with a position inside a triangle having its vertices at the positions of the mounts 46a to 46c. This may make it possible to stably support the housing 24 and, even when moving the housing 24 in the V or −V direction, suppress a misalignment of the line narrow module 14. Further, the position of the line narrow module 14 in the V direction can be adjusted with high accuracy according to the number of rotations of the rotating rod 51b.

In other respects, the third embodiment may be identical to the first embodiment.

In the foregoing description, the center of gravity of the housing 24 accommodating the line narrow module 14 is overlapped, in the V direction, with a position inside a triangle having its vertices at the positions of the mounts 46a to 46c. In the present disclosure, the center of gravity of the housing 24 accommodating the line narrow module 14 may be further overlapped, in the V direction, with the center of gravity of a triangle having its vertices at the positions of the mounts 46a to 46c.

### 5. Laser Apparatus Capable of Moving Housing Moving Device (Fourth Embodiment)

FIGS. 5A to 5E illustrate configurations and operations of a line narrow module and a housing moving device according to a fourth embodiment. FIGS. 5A to 5E omit to illustrate the laser chamber 10, the output coupling mirror 15, and the like. FIGS. 5A to 5E are diagrams as viewed from a direction substantially parallel to the direction of travel of a laser beam that is outputted from the output coupling mirror 15.

In the fourth embodiment, the laser apparatus including the laser chamber 10, the output coupling mirror 15, the line narrow module 14, and the like may be configured to be held by a holding device 33. The holding device 33 may include the plate 20a and the pedestal 30. The plate 20a may have bolt holes 27 formed therein to fix the housing 24 accommodating the line narrow module 14. A first moving mechanism 34 may be disposed on the pedestal 30 of the holding device 33. A stopper 35 may be disposed at an end of the first moving mechanism 34 on the −H direction side.

As shown in FIG. 5A, the housing 24 and the housing moving device 50 may be carried by a cart 36. The cart 36 may have wheels 36a that enable the cart 36 to move over a floor surface. The wheels 36a may have stoppers (not illustrated) and may have height adjusting mechanisms (not illustrated).

A second moving mechanism 37 may be disposed on the upper surface of the cart 36. The plate 31 may have wheels 54 so that the housing moving device 50 according to the fourth embodiment can move along the second moving mechanism 37. The housing moving device 50 may be fixed to the cart 36 by a fixing member 55 and bolts.

The cart 36 may move to one side of the holding device 33 with the housing 24 and the housing moving device 50 loaded on the cart 36. With the cart 36 laid alongside the holding device 33, the second moving mechanism 37 may be connected to the first moving mechanism 34 by a connecting member 56 so that the cart 36 may be fixed to the holding device 33.

Next, as shown in FIG. 53, the housing moving device 50 may be removed from the fixing member 55. Then, the housing moving device 50 supporting the housing 24 may be moved to the holding device 33 by the second moving mechanism 37 and the first moving mechanism 34. The housing moving device 50 may be positioned by the stopper 35 disposed at the first moving mechanism 34.

Next, as shown in FIG. 5C, the connecting member 56 may be removed so that the cart 36 may be removed from the holding device 33. Furthermore, the housing moving device 50 may be fixed to the holding device 33 by the fixing member 55 and the bolts. Then, the rotating rod 51b of the housing moving device 50 may be rotated so that the height of the housing 24 accommodating the line narrow module 14 may be adjusted. FIG. 5C illustrates a case where the housing 24 is located in a lower position so that the upper half of the grating 14c is used. FIG. 5D illustrates a case where the housing 24 is located in a higher position so that the lower half of the grating 14c is used. Once the height of the housing 24 accommodating the line narrow module 14 is determined, the housing 24 may be fixed to the plate 20a of the holding device 33 by bolts.

Next, as shown in FIG. 5E, with the housing 24 remaining fixed to the plate 20a while accommodating the line narrow module 14, the fixing member 55 may be removed so that the housing moving device 50 may be removed.

In other respects, the fourth embodiment may be identical to the third embodiment.

According to the fourth embodiment, the housing moving device 50 allows the housing 24 not only to move upward and downward but also to stably move in both the H and −H directions.

### 6. Housing Moving Device Including Jack Device (Fifth Embodiment)

FIGS. 6A and 6B illustrate configurations and operations of a line narrow module and a housing moving device according to a fifth embodiment. FIGS. 6A and 6B omit to illustrate the laser chamber 10, the output coupling mirror 15, and the like. FIGS. 6A and 6B are diagrams as viewed from a direction substantially parallel to the direction of travel of a laser beam that is outputted from the output coupling mirror 15.

Unlike the housing moving device 50 according to the third or fourth embodiment, a housing moving device 50a according to the fifth embodiment does not need to include a cam mechanism. The housing moving device 50a according to the fifth embodiment may include a jack device. In other respects, the fifth embodiment may be identical to the fourth embodiment.

The jack device of the housing moving device 50a may have a plate 57a, a plate 57b, a link mechanism 57c, and a rotating rod 57d. The plate 57a may be disposed on the plate 31.

The link mechanism 57c may have its lower end connected to the plate 57a and its upper end connected to the plate 57b. The rotating rod 57d may be rotatable on an axis of rotation extending in a longitudinal direction. The rotating rod 57d may have a screw portion 57e. Rotation of the rotating rod 57d may extend or reduce the distance between the lower and upper ends of the link mechanism 57c.

A plurality of legs including legs 46d and 46e and at least one leg (not illustrated) may be fixed to the lower surface of the housing 24. The plurality of legs may be placed on the plate 57b so that the housing 24 is supported by the housing moving device 50a.

FIG. 6A illustrates a state where the housing moving device 50a supporting the housing 24 is loaded on the cart 36. The cart 36 may be laid alongside the holding device 33.

FIG. 6B illustrates a state where the housing moving device 50a supporting the housing 24 has been moved to the holding device 33 and the housing 24 has been moved to a higher position. With the rotation of the rotating rod 57d, the jack device of the housing moving device 50a may be able to move the housing 24 upward and downward. For example, the housing 24 may be located in a lower position so that the upper half of the grating 14c is used. Further, the housing 24 may be located in a higher position so that the lower half of the grating 14c is used. The housing 24 may be fixed to the plate 20a of the holding device 33 by bolts.

The plurality of legs 46d and 46e fixed to the lower surface of the housing 24 may be made of a material having a low coefficient of friction with the plate 57b. This may facilitate an operation of fixing the housing 24 to the plate 20a. Alternatively, instead of the plurality of legs, wheels with stoppers may be disposed on the lower surface of the housing 24.

Once the housing 24 is fixed to the plate 20a, the housing moving device 50a may be removed.

### 7. Housing Moving Device Including V-Direction Shafts (Sixth Embodiment)

FIGS. 7A and 7B illustrate configurations and operations of a line narrow module and a housing moving device according to a sixth embodiment. FIGS. 7A and 7B omit to illustrate the laser chamber 10, the output coupling mirror 15, and the like. FIGS. 7A and 7B are diagrams as viewed from a direction substantially parallel to the direction of travel of a laser beam that is outputted from the output coupling mirror 15.

A housing moving device 50b according to the sixth embodiment may include a plurality of V-direction shafts 58b. The housing moving device 50b may further include a plate 57a, a plate 57b, a cam feeder 51, a linear cam 52, and a cam follower 53h. The number of the linear cams 52 and the number of the cam followers 53h may each be one or more. The plate 57a may be disposed on the plate 31. In other respects, the sixth embodiment may be identical to the fourth embodiment.

The plurality of V-direction shafts 58b may have their lower ends fixed to the plate 57a. Each of the plurality of V-direction shafts 58b may penetrate a through-hole formed in the plate 57b. This may allow the plate 57b to move in the V and −V directions and may not allow the plate 57b to move in other directions.

A plurality of legs including legs 46d and 46e and at least one leg (not illustrated) may be fixed to the lower surface of the housing 24. The plurality of legs may be placed on the plate 57b so that the housing 24 may be supported by the housing moving device 50b.

The cam feeder 51 may include a rod supporting unit 51a, a rotating rod 51b, and a linear motion unit 51e. The rod supporting unit 51a may be fixed to the plate 31. The rotating rod 51b may be supported by the rod supporting unit 51a so that movement of the rotating rod 51b in a longitudinal direction is restricted. The rotating rod 51b may be rotatable on an axis of rotation extending in the longitudinal direction. The rotating rod 51b may have a feed screw portion 51d. The feed screw portion 51d may be a portion of the rotating rod 51b where a male screw has been formed on an outer circumferential surface thereof. The linear motion unit 51c may have a female screw formed in an inner circumferential surface thereof, and the feed screw portion 51d may be screwed into the linear motion unit 51c. The linear motion unit 51c may be fixed to a bracket 52a of the linear cam 52 so that rotation of the linear motion unit 51c may be restricted. The linear motion unit 51c may reciprocate in the longitudinal direction of the rotating rod 51b as the rotating rod 51b having the feed screw portion 51d rotates.

The linear cam 52 may include the bracket 52a, a connecting pole 52b, and a slope unit 52h. The bracket 52a may be fixed to the linear motion unit 51c of the cam feeder 51. The connecting pole 52b may have its first end fixed to the bracket 52a. The connecting pole 52b may have its second end fixed to the slope unit 52h. The slope unit 52h may have an inclined surface, which becomes higher along the H direction and becomes lower along the −H direction. The linear cam 52 may reciprocate in the H and −H directions as the linear motion unit 51c of the cam feeder 51 reciprocates. As the linear cam 52 reciprocates, the cam follower 53h may move upward and downward to move the housing 24 upward and downward. The cam follower 53h may be replaced by the elevator 53 according to the third or fourth embodiment.

FIG. 7A illustrates a state where the housing moving device 50b supporting the housing 24 is loaded on the cart 36. The cart 36 may be laid alongside the holding device 33.

FIG. 7B illustrates a state where the housing moving device 50b supporting the housing 24 has been moved to the holding device 33 and the housing 24 has been moved to a higher position. With the rotation of the rotating rod 51b, the linear cam 52 may be able to move the housing 24 upward and downward. For example, the housing 24 may be located in a lower position so that the upper half of the grating 14c is used. Further, the housing 24 may be located in a higher position so that the lower half of the grating 14c is used. The housing 24 may be fixed to the plate 20a of the holding device 33 by bolts.

The plurality of legs 46d and 45e fixed to the lower surface of the housing 24 may be made of a material having a low coefficient of friction with the plate 57b. This may facilitate an operation of fixing the housing 24 to the plate 20a. Alternatively, instead of the plurality of legs, wheels with stoppers may be disposed on the lower surface of the housing 24. Once the housing 24 is fixed to the plate 20a, the housing moving device 50b may be removed.

### 8. Housing Moving Device Including Springs (Seventh Embodiment)

FIGS. 8A and 8B illustrate configurations and operations of a line narrow module and a housing moving device according to a seventh embodiment. FIGS. 8A and 8B omit to illustrate the laser chamber 10, the output coupling mirror 15, and the like. FIGS. 8A and 8B are diagrams as viewed from a direction substantially parallel to the direction of travel of a laser beam that is outputted from the output coupling mirror 15.

A housing moving device 50c according to the seventh embodiment may include springs 58a. The housing moving device 50c may further include a plate 57a, a plate 57b, and a plurality of V-direction shafts 58b. The plate 57a may be disposed on the plate 31. In other respects, the seventh embodiment may be identical to the fourth embodiment.

Each of the V-direction shafts 58b may have its lower end fixed to the plate 57a. Each of the V-direction shafts 58b may penetrate a through-hole formed in the plate 57b. This may allow the plate 57b to move in the V and −V directions and may not allow the plate 57b to move in other directions.

A plurality of legs including legs 46d and 46e and at least one leg (not illustrated) may be fixed to the lower surface of the housing 24. The plurality of legs may be placed on the plate 57b so that the housing 24 is supported by the housing moving device 50c.

The springs 58a may be disposed between the plate 57a and the plate 57b. If the housing 24 is placed on the plate 57b, the springs 58a may be compressed. With the resulting force of restitution, the springs 58a may support the load of the housing 24. The difference in length of each spring 58a between before and after the housing 24 is placed on the plate 57b may be equal to or greater than the beam width of the laser beam in the V direction.

FIG. 8A illustrates a state where the housing moving device 50c supporting the housing 24 is loaded on the cart 36. The cart 36 may be laid alongside the holding device 33.

FIG. 8B illustrates a state where the housing moving device 50c supporting the housing 24 has been moved to the holding device 33 and the housing 24 has been moved to a higher position. The force of restitution of the springs 58a may enable an operator to lift the housing 24 with a force that is smaller than the gravitational force applied to the housing 24. The housing 24 may be fixed to the plate 20a of the holding device 33 by bolts.

The plurality of legs 46d and 46e fixed to the lower surface of the housing 24 may be made of a material having a low coefficient of friction with the plate 57b. This may facilitate an operation of fixing the housing 24 to the plate 20a. Alternatively, instead of the plurality of legs, wheels with stoppers may be disposed on the lower surface of the housing 24.

Further, in the seventh embodiment, since the plate 57b is supported by the springs 58a, the inclination of the plate 57b may be adjustable. This may facilitate an operation of fixing the housing 24 to the plate 20a.

Once the housing 24 is fixed to the plate 20a, the housing moving device 50c may be removed.

### 9. Housing Moving Device Including Integrated Rail (Eighth Embodiment)

FIGS. 9A and 9B illustrate configurations and operations of a line narrow module and a housing moving device according to an eighth embodiment. FIGS. 9A and 9B omit to illustrate the laser chamber 10, the output coupling mirror 15, and the like. FIGS. 9A and 9B are diagrams as viewed from a direction substantially parallel to the direction of travel of a laser beam that is outputted from the output coupling mirror 15.

The first and second moving mechanisms 34 and 37 in the seventh embodiment may be replaced by an integrated moving mechanism 37a in the eighth embodiment. The moving mechanism 37a may be a rail. The moving mechanism 37a and a pedestal 30a may be fixed to the cart 36. In other respect, the eighth embodiment may be identical to the seventh embodiment.

FIG. 9A illustrates a state where the housing moving device 50d supporting the housing 24 is loaded on the cart 36. The cart 36 may be laid alongside the holding device 33. The pedestal 30a and the moving mechanism 37a, which are fixed to the cart 36, may be inserted in the holding device 33. The moving mechanism 37a may allow the housing 24 to move to the inside of the housing device 33.

FIG. 9B illustrates a state where the housing 24 has been fixed to the plate 20a of the holding device 33 by bolts. Once the housing 24 is fixed to the plate 20a, the housing moving device 50d may be removed. The pedestal 30a and the moving mechanism 37a, which are fixed to the cart 36, as well as the housing moving device 50d, may be removed from the holding device 33.

### 10. Suspending Housing Moving Device (Ninth Embodiment)

FIG. 10 illustrates configurations and operations of a line narrow module and a housing moving device according to a ninth embodiment. FIG. 10 omits to illustrate the laser chamber 10, the output coupling mirror 15, and the like. FIG. 10 is a diagram as viewed from a direction substantially parallel to the direction of travel of a laser beam that is outputted from the output coupling mirror 15.

A housing moving device 50e according to the ninth embodiment may include a crane device. The crane device may have wheels 59a that enable the crane device to move over the floor surface. The wheels 59a may have stoppers (not illustrated).

The housing moving device 50e may have a column unit 59b and a horizontal unit 59c. The wheels 59a may be attached to a lower end of the column unit 59b. The horizontal unit 59c may be attached to the column unit 59b. The column unit 59b may be provided with an elevating device (not illustrated) for moving the horizontal unit 59c upward and downward in the V and −V directions. The horizontal unit 59c may support a suspending unit 59e. The suspending unit 59e may be enabled by a moving mechanism 59d to move in the H and −H directions.

With the housing 24 suspended by the suspending unit 59e, up-and-down movement of the horizontal unit 59c by the elevating device (not illustrated) and movement of the suspending unit 59e by the moving mechanism 59d may be possible. The housing 24 may be moved to the inside of the holding device 33 by the elevating device (not illustrated) and the moving mechanism 59d. Once the housing 24 is moved to the inside of the holding device 33, the housing 24 may be fixed to the plate 20a of the holding device 33 by bolts.

Once the housing 24 is fixed to the plate 20a, the housing moving device 50e may be removed from the housing 24.

### 11. Laser Apparatus Having Grating Moving Device and Housing Moving Device (Tenth Embodiment)

FIGS. 11A to 11D illustrate a configuration and operation of a line narrow module according to a tenth embodiment. FIGS. 11A to 11D omit to illustrate the laser chamber 10, the output coupling mirror 15, and the like. FIGS. 11A to 11D are diagrams as viewed from a direction substantially parallel to the dispersion plane of the grating and substantially perpendicular to the direction of travel of a laser beam that is outputted from the output coupling mirror 15.

In the tenth embodiment, both up-and-down movement of the grating 14c by a grating moving device (not illustrated) and up-and-down movement of the housing 24 by a housing moving device (not illustrated) may be possible. Therefore, the grating moving device according to the tenth embodiment may be configured to change the relative position of the grating 14c with respect to the housing 24. The grating moving device (not illustrated) may be identical in specific configuration and function to that described in the first or second embodiment. The housing moving device (not illustrated) may be identical in specific configuration and function to that described in one of the third to ninth embodiments.

The widths of the prisms 14a and 14b and the through-hole 24d in the V direction may be equal to or greater than double the beam width of the laser beam in the V direction. The width of the grating 14c in the V direction may be equal to or greater than quadruple the beam width of the laser beam in the V direction and greater than the widths of the prisms 14a and 14b in the V direction.

As shown in FIG. 11A, when the housing 24 is placed in a higher position by the housing moving device (not illustrated), the lower halves of the prisms 14a and 14b may be used. When, in this state, the grating 14c is placed in the highest position by the grating moving device (not illustrated), the lowermost portion of the grating 14c may be used.

As shown in FIG. 11B, when the housing 24 is placed in a higher position, the grating 14c may be placed in an intermediate position between the highest position and the lowest position by the grating moving device (not illustrated). This may cause the lower halves of the prisms 14a and 14b to be used and cause the second lowest portion of the grating 14c to be used.

As shown in FIG. 11C, with the grating 14c placed in the intermediate position between the highest position and the lowest position, the housing 24 may be placed in a lower position by the housing moving device (not illustrated). This may cause the upper halves of the prisms 14a and 14b to be used and cause the second highest portion of the grating 14c to be used. The state shown in FIG. 11B and the state shown in FIG. 11C may be identical in terms of the relative position of the grating 14c with respect to the housing 24.

As shown in FIG. 11D, with the housing 24 placed in a lower position, the grating 14c may be placed in the lowest position by the grating moving device (not illustrated). This may cause the upper halves of the prisms 14a and 14b to be used and cause the uppermost portion of the grating 14c to be used.

The tenth embodiment enables four arrangements respectively shown in FIGS. 11A, 11B, 11C, and 11D, allowing the grating 14c to be used in four portions. Further, since the lower halves of the prisms 14a and 14b are used in FIGS. 11A and 11B and the upper halves of the prisms 14a and 14b are used in FIGS. 11C and 11D, the prisms 14a and 14b can be used in two portions.

Although, as mentioned above, the prisms 14a and 14b may be damaged by the laser beam, they may be damaged less than the grating 14c. According to the tenth embodiment, since the housing 24 accommodating the line narrow module 14 is moved in an integrated manner and only the grating 14c can be moved, the prisms 14a and 14b do not need to be able to be used in four portions. Accordingly, the prisms 14a and 14b may be small in height.

Further, if the position of the grating 14c is made adjustable in four levels with the housing 24 in a fixed position, the housing 24 may need to have a large size to cover the stroke of the four levels. This may make it necessary to fill the housing 24 with a large amount of inert gas. In contrast, the tenth embodiment may reduce the stroke of movement of the grating 14c, allowing the housing 24 to be small. This may make it possible to reduce the quantity of flow of insert purge gas in the housing 24 and the weight of the housing 24.

The aforementioned descriptions are intended to be taken only as examples, and are not to be seen as limiting in any way. Accordingly, it will be clear to those skilled in the art that variations on the embodiments of the present disclosure can be made without departing from the scope of the appended claims.

The terms used in the present specification and in the entirety of the scope of the appended claims are to be interpreted as not being limiting. For example, wording such as “includes” or “is included” should be interpreted as not being limited to the item that is described as being included. Furthermore, “has” should be interpreted as not being limited to the item that is described as being had. Furthermore, the modifier “a” or “an” as used in the present specification and the scope of the appended claims should be interpreted as meaning “at least one” or “one or more”.

1. A narrow band laser apparatus comprising:
a laser chamber;
a line narrow module configured to narrow a band width of a laser beam outputted from the laser chamber and return the laser beam to the laser chamber, the line narrow module including a grating;
a housing accommodating the line narrow module;
three mounts fixed to the housing; and
a housing moving device configured to support the housing and the line narrow module by supporting each of the three mounts and move the line narrow module by moving the housing with respect to the laser chamber in a direction substantially perpendicular to a dispersion plane of the grating.

2. The narrow band laser apparatus according to claim 1, wherein the housing moving device is any one of:
a device including a jack mechanism;
a device including springs configured to support a load of the housing accommodating the line narrow module; and
a device including shafts configured to restrict a posture of and a movement direction of the housing.

3. A narrow band laser apparatus comprising:
a laser chamber;
a line narrow module configured to narrow a band width of a laser beam outputted from the laser chamber and return the laser beam to the laser chamber, the line narrow module including a grating;
a housing accommodating the line narrow module;
a housing moving device configured to move the line narrow module by moving the housing with respect to the laser chamber in a direction substantially perpendicular to a dispersion plane of the grating; and
a grating moving device configured to, in the housing, move the grating with respect to the housing in a direction substantially perpendicular to the dispersion plane of the grating.

4. The narrow band laser apparatus according to claim 3, wherein the housing moving device is any one of:
a device including a jack mechanism;
a device including springs configured to support a load of the housing accommodating the line narrow module; and
a device including shafts configured to restrict a posture of and a movement direction of the housing.

5. The narrow band laser apparatus according to claim 3, wherein
the line narrow module further includes a beam expander disposed in an optical path of the laser beam between the laser chamber and the grating,
a length of the beam expander along a movement direction of the grating is equal to or greater than double a beam width of the laser beam along the movement direction of the grating, and
a length of the grating along the movement direction of the grating is equal to or greater than quadruple the beam width of the laser beam along the movement direction of the grating.

6. The narrow band laser apparatus according to claim 5, wherein the housing moving device and the grating moving device are configured to be switchable among
a first mode in which the housing is placed in a first position by the housing moving device so that the laser beam is incident on a first portion of the beam expander and the grating is placed in a first relative position with respect to the housing by the grating moving device so that the laser beam is incident on a first portion of the grating,
a second mode in which the housing is placed in the first position by the housing moving device so that the laser beam is incident on the first portion of the beam expander and the grating is placed in a second relative position with respect to the housing by the grating moving device so that the laser beam is incident on a second portion of the grating,
a third mode in which the housing is placed in a second position by the housing moving device so that the laser beam is incident on a second portion of the beam expander and the grating is placed in the second relative position with respect to the housing by the grating moving device so that the laser beam is incident on a third portion of the grating, and
a fourth mode in which the housing is placed in the second position by the housing moving device so that the laser beam is incident on the second portion of the beam expander and the grating is placed in a third relative position with respect to the housing by the grating moving device so that the laser beam is incident on a fourth portion of the grating.

7. A method for positioning a housing with respect to a laser chamber using:
the laser chamber;
a line narrow module configured to narrow a band width of a laser beam outputted from the laser chamber and return the laser beam to the laser chamber, the line narrow module including a grating;
the housing accommodating the line narrow module;
a housing moving device configured to support the housing and move the housing in a direction substantially perpendicular to a dispersion plane of the grating;
a holding device configured to position the housing with respect to the laser chamber and hold the housing;
a first moving mechanism configured to move the housing moving device with respect to the holding device in a direction intersecting a movement direction of the housing by the housing moving device;
a cart configured to be able to hold and carry the housing moving device supporting the housing; and
a second moving mechanism configured to move the housing moving device supporting the housing with respect to the cart in the direction intersecting the movement direction of the housing by the housing moving device,
the method comprising:
by using the cart, holding and carrying the housing moving device supporting the housing to a vicinity of the holding device;
connecting the second moving mechanism to the first moving mechanism;
by using the second moving mechanism and the first moving mechanism, moving the housing moving device supporting the housing to the holding device;
by using the holding device, positioning and holding the housing with respect to the laser chamber; and
by using the first moving mechanism, removing the housing moving device from the housing and the holding device.
